(19) United States
(12) Patent Application Publication
(10) Pub. No.: US 2009/0210724 A1
(43) Pub. Date: Aug. 20, 2009

(54) CONTENT MANAGEMENT METHOD AND CONTENT MANAGEMENT APPARATUS

(76) Inventor: Yoshihiro Hori, Gifu (JP)

Correspondence Address: MCDERMOTT WILL & EMERY LLP, 600 13TH STREET, N.W., WASHINGTON, DC, 20005-3096, US

(21) Appl. No.: 12/300,238

(22) PCT Filed: Mar. 26, 2007
(86) PCT No.: PCT/JP2007/000297

§ 371 Date: Nov. 10, 2008

(30) Foreign Application Priority Data
May 10, 2006 (JP) 2006-132025

(51) Int. Cl. G06F 21/24; H04L 9/08; G01C 21/00

(52) U.S. Cl. 713/193; 701/200

(57) ABSTRACT

A technique is provided which protects copyrights of contents and at the same time enhances the user's convenience.

When a user makes a request of the use or duplication of map data stored in a storage device via an operating unit, a control unit first causes an encryption engine to read out a content key from the storage device. Then it causes a license generator to encrypt the read-out content key with a device ID stored in a device ID storage. License data containing the content key thus generated are transferred to the storage device via the encryption engine and are overwritten and replaced by license data recorded in the storage device.

### TECHNICAL FIELD

The present invention relates to a content data management technique and, in particular, to a content management method and a content management apparatus for managing the duplication of a content key with which to decrypt encrypted content data.

### BACKGROUND TECHNOLOGY

As a copyright protection method for protecting content data, well known is a method where the content data are encrypted and content usage information containing a decryption key (hereinafter referred to as “content key”) for decrypting the encrypted content data is managed by enhancing the secrecy thereof (See Patent Document 1, for instance). Such usage information will be hereinafter referred to as “license data”. For the data distribution system disclosed in Patent Document 1, three devices which are a distribution server, a memory card as a storage device and a content reproducing device, for a mobile phone, as a utilization device may serve as devices handling the license data. An encrypted communication channel is established between the distribution server and the storage device and between the storage device and the utilization device, so that the license data is transmitted and received through this encrypted communication channel. The distribution server, the storage device and the utilization device are each provided with a TRM (Tamper Resistant Module) to handle the encrypted license data.

In the establishing of the encrypted communication channel, a device that provides license data (hereinafter referred to as “license providing device” or “licenser device”) sends a certificate containing a public key to a device that receives the license data (hereinafter referred to as “license receiving device” or “licensee device”. Then the license providing device verifies this certificate. If, as a result of the verification, the certificate sent from the license receiving device is the authentic one and is not invalidated by a certificate-nullification list, keys will be exchanged between the devices using the public key contained in this certificate. Then the license data encrypted by the use of the key sent to the license receiving device from the license providing device are transmitted to the license receiving device from the license providing device. TRM is a circuit module where the confidentiality is physically protected, and is structured such that the license data can be exchanged through the encrypted communication channel only.

As described above, by employing this copyright protection method, the copyrights of the contents are completely protected by the encryption of the content data and the secrecy of the license data. Further, usage restriction is introduced by controlling the number of times of reproduction, the number of times of copying or the like, and the movement or transfer is controlled. Hence such restriction and control may be applied to various distribution services or enable the recording of digital broadcasting.

[Patent Document 1] Japanese Patent Application Laid-Open No. 2002-366442

### DISCLOSURE OF THE INVENTION

### Problems to be Solved by the Invention

In recent years, car navigation devices or GPS navigation system have been in wide use. The car navigation device, which is mounted on an automobile or the like, displays a map thereon and guides routes for a user to reach a destination. When the car navigation devices start to gain popularity in the beginning, a CD-ROM was used as a storage medium for storing map data. To display more detailed map, a car navigation device is starting to be available which stores the map data in a larger-capacity hard disk device. Under such circumstances, the inventor of the present invention has come to recognize the need of a technique that enables the user to produce duplicates for backup purposes while the copyrights are completely protected by the above-described copyright protection schemes so as to be convenient for the user.

The present invention has been made in view of the foregoing circumstances, and a general purpose thereof is to provide a technique capable of enhancing the user's convenience by protecting the copyrights of contents.

### Means for Solving the Problems

One embodiment of the present invention relates to a content management method. When content data encrypted with a content key and the content key are read from a portable storage device that stores the content key in order to use the encrypted content data or in order to duplicate the content key, this content management method comprises: receiving a request for a use of the content data or a duplication of the content key; reading the content key from the storage device; determining whether or not the read content key is encrypted using information which is unique to a utilization apparatus capable of decrypting the encrypted content data and is so secretly kept as not to be leaked to the outside; encrypting the content key using the information which is unique to a utilization apparatus capable of decrypting the encrypted content data and is so secretly kept as not to be leaked to the outside, when the content key is not encrypted; and sending the encrypted content key to the storage device so as to be recorded in substitution for the content key.

At the start of the use of the content data or at the time of duplication of the content key, the content key is encrypted with the information unique and secret to the apparatus, so that the content key is bound to (associated with) the apparatus. Thereafter, the content data cannot be decrypted by any other devices other than this apparatus. This allows a user to produce a duplicate for backup purposes in such a mode where the duplicate is usable in the apparatus only and the use thereof by any other devices is not permitted, thus being convenient for the user. At the same time, this can appropriately protect the copyrights of contents.

The content management method may further comprise recording the encrypted content key in a storage device which is a copying destination, when the request for a duplication of the content key is received.

The content management method may further comprise storing the read content key in a memory for storing data so secretly as not to be leaked to the outside. The content key stored in the memory may be erased when the duplication has been completed. Or the content key stored in the memory may be continuously stored thereafter and may be used to decrypt the content data.

The apparatus may store a model ID assigned to identify a same type of apparatus group; the content key may be encrypted with the model ID; and the method may further comprise decrypting the content key encrypted with the model ID prior to the encrypting the content key. As a result, the content key can only be decrypted by a specific apparatus group to which the model ID has been assigned in advance. Thus the security of content keys can be further enhanced and the content data can be protected appropriately.

The information which is unique to a utilization apparatus and is so secretly kept as not to be leaked to the outside may be an ID of the apparatus. The content key may be encrypted and inputted/outputted between the storage device and the apparatus.

When the request for a use of the content data is received, the content management method may further comprise: reading the content key from the storage device; determining whether or not the read content key read is encrypted using information which is unique to a utilization apparatus and is so secretly kept as not to be leaked to the outside; decrypting the content key using the information which is unique to its own apparatus and is so secretly kept as not to be leaked to the outside, when the content key is encrypted; reading the encrypted content key from the storage device; and decrypting the read encrypted content data using the decrypted content key.

The content data may be map data, and the apparatus may be a car navigation device.

Another embodiment of the present invention relates to a content management apparatus. This content management apparatus comprises: an input/output unit which inputs and outputs a content key used to decrypt encrypted content data between portable storage devices; a unique information storage which stores information unique to its own apparatus so that the unique information is not leaked to the outside; a generation unit which encrypts the content key with the unique information; an operating unit which receives a request for a use of the content data using the content key or a duplication of the content key; and a control unit which acquires the content key stored in the storage device by the input/output unit, encrypts the acquired content key by the generation unit using the information unique to its own apparatus, and sends the encrypted content key to the storage device by the input/output device so as to be recorded in substitution for the content key, when the request for a use of the content data or a duplication of the content key is received.

When the request for a duplication of the content data is received, the control unit may send the encrypted content key to a storage device which is a copying destination by the output/input unit.

The content management apparatus may further comprise a license memory which stores data so secretly as not to be leaked to the outside, wherein when the request for a use of the content data or a duplication of the content key is received, the content key stored in the storage device may be moved to the license memory, encrypt the content key stored in the license memory by the generation unit using the unique information, and send the encrypted content key to the storage device by the output/input unit so as to be duplicated onto the storage device.

The content management apparatus may further comprise: a model ID storage which stores a model ID assigned to identify a same type of apparatus group; and a license reading unit which decrypts encrypted content key with the model ID stored in the model ID storage, when the content key acquired from the storage device is encrypted with the model ID.

The unique information is a device ID of the content management apparatus. When inputting and outputting the content key to and from the storage device, the input/output unit may input and output the content key after encrypting the content key.

The content management apparatus may further comprise: a reading unit which decrypts the content key encrypted with information unique to the content management apparatus; and a content decryption unit which decrypts the encrypted content data using the content key, wherein when a request for decryption of the content data is received, the control unit may acquire the content key stored in the storage device from the input/output unit; and when the acquired key is encrypted, the content key may be decrypted by the license reading unit so as to be supplied to the content decryption unit and the encrypted content data acquired from the storage device may be decrypted by the content decryption unit.

The content data may be map data, and the content management apparatus may be a car navigation device.

### EFFECT OF THE INVENTION

The present invention protects the copyrights of contents, so that the user's convenience can be enhanced.

### BRIEF DESCRIPTION OF THE DRAWINGS

FIG. 1 is a diagram showing a general structure of a data management system according to the base technology.

FIG. 2 is a diagram showing an internal structure of a recording/reproducing device according to the base technology.

FIG. 3 is a diagram showing an internal structure of a primary-use license generating unit and a content encryption unit.

FIG. 4 is a diagram showing a data structure of license data.

FIG. 5 is a diagram showing an internal structure of a license reading unit.

FIG. 6 is a diagram showing another example of the internal structure of a primary-use license generating unit and a content encryption unit.

FIG. 7 is a diagram showing another example of the internal structure of a license reading unit.

FIG. 8 shows an internal structure of a storage device.

FIG. 9 is a diagram showing an internal structure of an encryption engine in the recording/reproducing device shown in FIG. 2.

FIG. 10 is a diagram showing an internal structure of an encryption engine in the recording/reproducing device shown in FIG. 2.

FIG. 11 shows an internal structure of an encryption engine in the storage device shown in FIG. 8.

FIG. 12 shows steps performed until a recording/reproducing device records license data in a storage device.

FIG. 13 shows steps performed until a recording/reproducing device records license data in a storage device.

FIG. 14 is a flowchart showing write-transfer processing of license data in FIG. 13.

FIG. 15 shows a structure of a car navigation device according to an embodiment.

FIGS. 16(a) and 16(b) schematically show internal data of a storage device.

FIG. 17 shows another exemplary structure of a car navigation device.

FIGS. 18(a) and 18(b) schematically show internal data of a storage device in the example shown in FIG. 17.

FIG. 19 shows still another exemplary structure of a car navigation device.

FIGS. 20(a) and 20(b) schematically show internal data of a storage device in the example shown in FIG. 19.

### DESCRIPTION OF THE REFERENCE NUMERALS

1 Data management system, 20 Storage medium, 100 Recording/reproducing device, 101 Controller, 103 Encryption engine, 104 Content encryption unit, 107 Primary-use license generating unit, 108 License reading unit, 109 Secondary-use license generating unit, 111 Content decryption unit, 162 ID shaping unit, 163 Content key encryption unit, 164 License data formatter, 166 Computing unit, 171 Format analysis unit, 172 ID shaping unit, 173 Content key decryption unit, 176 Computing unit, 200 Storage device, 201 Controller, 202 storage interface, 203 Encryption engine, 204 Tamper-resistant storage unit, 205 Normal data storage, 300 License using device, 400 Car navigation device, 401 Operating unit, 402 Control unit, 403 Map data processing unit, 404 Device ID storage, 405 Video memory, 406 Display, 407 License generator, 408 Model ID storage, 409 License memory

### BEST MODE FOR CARRYING OUT THE INVENTION

The embodiments of the present invention will now be described hereunder with reference to drawings. A description is first given of a technique for protecting contents as the base technology. In this base technology, a content key with which to encrypt the contents is encrypted or scrambled by the use of a device ID or the like of a reproducing device so that the contents cannot be decrypted and reproduced unless the device in question is a valid reproducing device. Subsequently, a description is given of a technique according to an embodiment of the present invention where when content data are to be duplicated for backup purposes, the contents cannot be decrypted unless a valid device is used.

In the base technology, when the content data such as music are to be duplicated, the content key is bound to (associated with) the device ID or the like of a reproducing device in order that the content data can also be reproduced by user's another reproducing device. In the embodiment, the duplication is intended for backup purposes in preparation for a case when the content data are unavailable due to storage device failure and the like. Hence, it is basically assumed in the embodiment that the contents can only be used on a single device and cannot be used by any other devices.

(Base Technology)

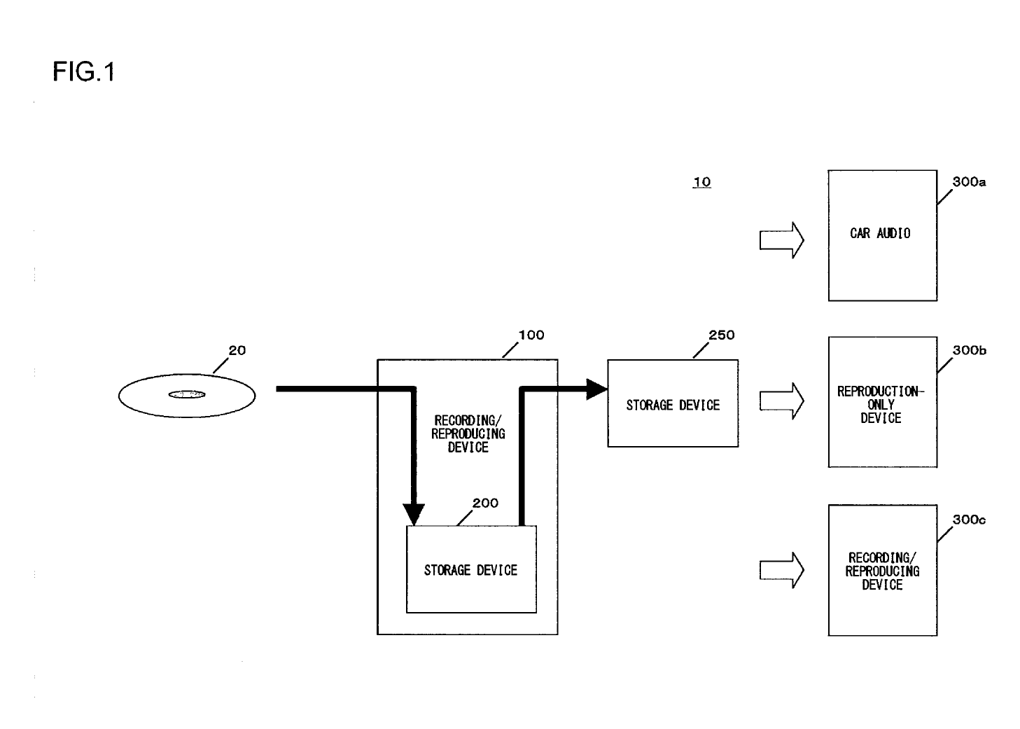

FIG. 1 shows a general structure of a data management system 10 according to the base technology. The data management system 10 includes a recording/reproducing device 100 which records such content data as music or videos stored on a storage medium 200 (CD, DVD, etc.) in a storage device 200 and reproduces the content data recorded on the storage medium 200, and a detachable storage device 250 which stores duplicates of the content data to enable the reproduction thereof by other devices such as a car audio 300a, a reproduction-only device 300b and a recording/reproducing device 300c.

The recording/reproducing device 100 retrieves the content data stored in the storage medium 20. Then the recording/reproducing device 100 generates a content key with which to encrypt the content data when storing them in the storage device 200, in such a format that the content key is bound to the recording/reproducing device 100, and records the content data by encrypting the content key. At this time, in order to protect the copyright of the content data, usage information affixed to the content data is acquired. Here, the usage information may contain information indicating the restriction on whether duplication is permitted or not, the number of times of duplication, the number of times of reproduction and the like. The recording/reproducing device 100 converts the format of the thus acquired usage information. Data resulting from the packaging of this usage information and the previously generated content key (hereinafter this packaged data will be referred to as “primary-use license data”) are encrypted and recorded in the storage device 200. Performing a binding (associating) on the recording/reproducing device 100 means that the content key cannot be retrieved from the primary-use license data unless identification data are used to identify the recording/reproducing device 100 or functional units of the recording/reproducing device 100. Such identification data contain, for example, the device ID of the recording/reproducing device 100, the device IDs embedded in semiconductor components and the like that constitute the recording/reproducing device 100, program IDs of softwares, such as an OS, installed in the recording/reproducing device 100, and embedded secret keys for use in encryption processing. Thus, the encrypted content data cannot be decrypted without using the identification data. A description is given herein on the assumption that the content key has been bound to the recording/reproducing device 100. However, the content key may be bound to an authorized user including those who have purchased the recording media 20. In the base technology described hereunder, a description will be given of a case, as an example, where the content key is bound to the device ID.

When reproducing the content data recorded in the storage device 200, the recording/reproducing device 100 reads out the encrypted primary-use license data from the storage device 200 so as to acquire the content key from the primary-use license data using the device ID. Then the encrypted content data are decrypted by the acquired content key so as to be reproduced. This enables preventing the unauthorized duplication of content data, so that the copyright of the content data can be appropriately protected.

In recent years, portable playback devices have been used widely. For example, the content data recorded in music CDs are stored up in the recording/reproducing device 100, such as a personal computer; and desired pieces of music are copied to a portable playback device and the user carries this device around him/her. This type of usage is in wide use today. In the base technology, the recording/reproducing device 100 copies the encrypted content data stored in the storage device 200 to the storage device 250. In so doing, the recording/reproducing device 100 generates secondary-use license data to be used exclusively for reproduction, from the primary-use license data stored in the storage device 200, and records them in the storage device 250. The secondary-use license data include a content key of a format which has not been bound to the recording/reproducing device 100 and usage permission information prohibiting other use than reproduction, so that the duplication of secondary-use license data is also prohibited. Accordingly, the copyrights of content data are appropriately protected. At the same time, the personal use of content data by the portable playback devices or the like is made possible, thus improving the user's convenience.

The storage device 250 in the base technology is not only the storage medium for storing data but also a drive-integrated portable storage device comprised of a controller that controls the input and output between a host device (e.g., recording/reproducing device 100) and the storage medium. In the base technology, a description is given of a portable hard disk drive, as an example for the storage device 250. Any type of storage devices may be used as the storage device 200; however, for the simplicity of explanation, a description is given herein of case where the storage device 200 is a drive-integrated storage device having the same functions as the storage device 250. Also, the storage device 200 may be realized by a hard disk built in the recording/reproducing device 100 or the like. Also, the recording medium for the storage device 250 may be realized by a semiconductor memory, CD-ROM, DVD or the like.

In general, the conventional hard disk drives are used in such a manner that each hard disk drive is fixedly connected to a certain host device. On the other hand, the storage devices 200 and 250 in the base technology are so structured that the storage devices 200 and 250 are each freely attachable to and detachable from a host device such as the recording/reproducing device 100. That is, the storage devices 200 and 250 in the base technology can be removed from the host device the same way as with CD, DVD and the like and carried with the user. And the storage devices 200 and 250 are storage devices that can be shared among a plurality of host devices including the car audio 300a, the reproduction-only device 300b, the recording/reproducing device 300c, or terminal devices connected to these devices via a communication cable or a communication network, in addition to the recording/reproducing device 100.

As described above, it is presupposed that the storage devices 200 and 250 are connected to a plurality of host devices. For instance, the storage devices 200 and 250 are connected to a third party's host device other than that owned by the user, so that it is possible that the recorded data may be read out thereby. Suppose that the contents to be protected by copyrights, such as music or images, and data to be kept confidential, such as classified information concerning corporations or individuals, are to be recorded. Then, in order to prevent those secret data from being leaked to the outside, the storage devices 200 and 250 themselves are each preferably provided with such a structure that data are appropriately protected, namely provided with a function that is sufficiently tamper-resistant.

Based on this perspective, the storage devices 200 and 250 in this base technology is provided with such a structure as to encrypt confidential data and exchange them when the confidential data are inputted and outputted between the storage devices and the host device. To store the confidential data, a classified data storage area separated from a normal storage area is provided. And the classified data storage area is structured such that the classified data storage area cannot be accessed without passing through encryption engines provided in the storage devices 200 and 250. This encryption engine inputs and outputs the confidential data to and from only a host device which has been verified to have valid authorization. Such a data protection function as this will be referred to as “secure function” also. The above-described structures and functions enable the data recorded in the storage devices 200 and 250 to be appropriately protected.

In order to maximize the features of the storage devices 200 and 250 as removable media, it is preferable that the normal data can be inputted to and outputted from a host device which is incompatible with the secure function. For this reason, the storage devices 200 and 250 in the base technology are compliant with ATA (AT Attachment) which is a standard of ANSI (American National Standards Institute) in order for the storage devices 200 and 250 to maintain compatibility with the conventional hard disks. Note that the above-mentioned secure function is realized as an extended instruction of ATA.

When the content data recorded on the storage medium 20 are to be recorded in the storage device 200 or 250, the content data themselves may be treated as confidential data. However, in the base technology the content data are encrypted and the encrypted data themselves are recorded on the storage data 200 or 250 as normal data. Then, data (hereinafter referred to as “license data”) containing information (hereinafter referred to as “usage information”) on the content key used to decrypt the encrypted content and information on a reproduction control on contents or a control on the usage, transfer and duplication of a license are inputted and outputted using the above-described secure function. As a result, sufficient tamper resistance is maintained; the input and output of data are simplified; the processing is done faster; and the power consumption is reduced.

It is assumed here that the license data contain identification ID information LID for identifying the license data, in addition to the content key or usage information. It is also assumed here that control information CC indicating the upper limit of the number of times of copying is contained therein as the usage information. Here, the control information CC is a 1-byte integer with no sign. This value indicates the upper limit of the number of times of copying and is subtracted by one whenever the license data is duplicated. CC=255 indicates that no upper limit is set and this is an exceptional case, and this value will not be changed as a result of duplication of the license data. Note that a method for setting the control information CC described herein and how to operate it are mere examples in the base technology and are not limited to any particular ones.

In what is to follow, of instructions that the host device (the recording/reproducing device 100, for example) issues to the storage devices 200 or 250, an extended instruction for the secure function will be also referred to “secure command” whereas the other instructions will be also referred to as “normal command”.

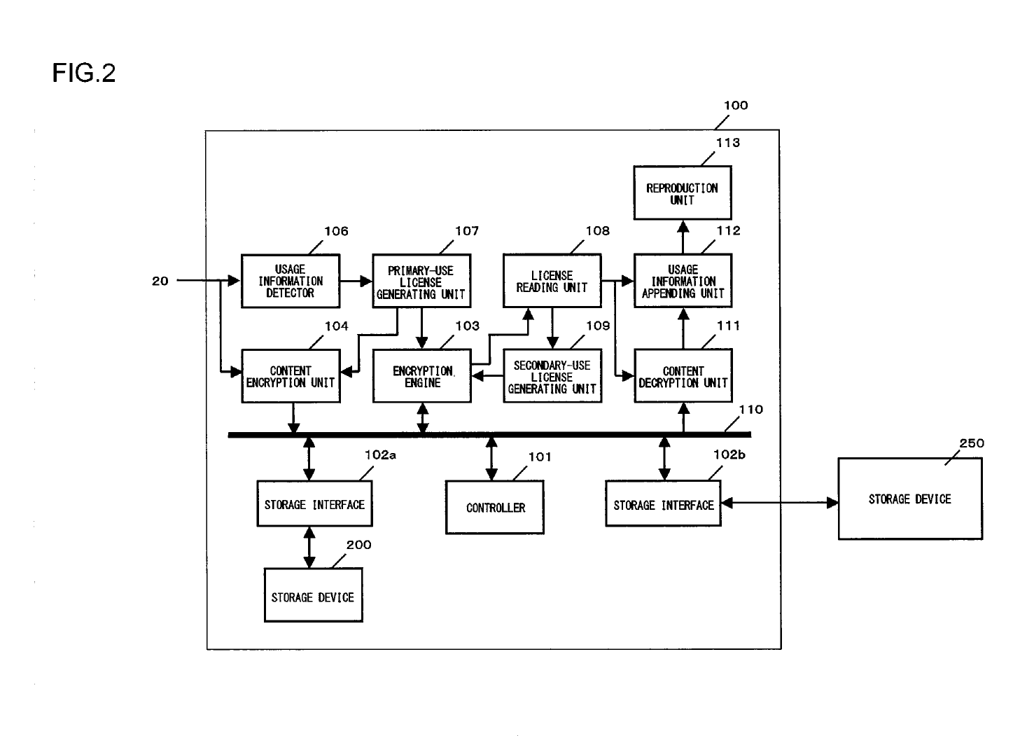

FIG. 2 shows an internal structure of the recording/reproducing device 100 according to the base technology. This structure may be realized hardwarewise by the use of a CPU, memory and other LSIs of an arbitrary computer, and softwarewise by memory-loaded programs or the like. Depicted herein are functional blocks realized by cooperation of those. Therefore, it will be understood by those skilled in the art that these functional blocks may be achieved by a variety of manners including hardware only, software only or a combination of both.

The recording/reproducing device 100 principally includes a controller 101, storage interfaces 102a and 102b, an encryption engine 103, a content encryption unit 104, a content decryption unit 111, a data bus 110 for electrically connecting these, a usage information detector 106, a primary-use license generating unit 107, a license reading unit 108, a secondary-use license generating unit 109, a usage information appending unit 112, and a reproduction unit 113. The storage device 200 may be incorporated into the recording/reproducing device 100 or provided in the recording/reproducing device 100 in a detachable manner as described above.

The usage information detector 106 detects usage information from among data stored in the storage medium 20. The usage information may be stored in a predetermined region of the storage medium 20, may be stored in a predetermined region of the content data or may be embedded in the content data using a watermarking technique or other techniques. The thus detected usage information is conveyed to the primary-use license generating unit 107.

The primary-use license generating unit 107 generates content keys used to encrypt the content data. Also, the primary-use license generating unit 107 generates usage information that inherits the usage information detected by the usage information detector 106. The primary-use license generating unit 107 generates primary-use license data usable in the recording/reproducing device 100, from the content keys and the usage information generated as above. The thus generated content keys are conveyed to the content encryption unit 104. The thus generated primary-use license data are conveyed to the encryption engine 103 and are recorded in the storage device 200 via the encryption engine 103.

The content encryption unit 104 encrypts the content data read out from the storage medium 20, using the content keys conveyed from the primary-use license generating unit 107. The encrypted content data are recorded in the storage device 200 using a normal command, via the data bus 110 and the storage interface 102a.

The encryption engine 103 controls encryption communication between the encryption engine 103 and the storage device 200 to input and output the primary-use license data to and from the storage device 200. Also, the encryption engine 103 controls encryption communication between the encryption engine 103 and the storage device 250 to record the secondary-use license data in the storage device 250. The structure and operation of the encryption engine 103 will be discussed in detail later. The storage interfaces 102a and 102b control the input and output of data to and from the storage devices 200 and 250, respectively. The controller 101 controls the constituent elements of the recording/reproducing device 100 in a unified manner.

The license reading unit 108 acquires the primary-use license data stored in the storage device 200 and interprets them so as to acquire the content keys and usage information. When the contents are to be reproduced in the recording/reproducing device 100, the license reading unit 108 determines whether reproduction is permitted or not by analyzing the usage information. If the reproduction is permitted, the license reading unit 108 will convey the content keys to the decryption unit 111 and convey the usage information to the usage information appending unit 112. When the license data are to be duplicated onto the storage device 250, the license reading unit 108 determines whether duplication is permitted or not by analyzing the usage information. If the duplication is permitted, the license reading unit 108 will convey the content keys and the usage information to the secondary-use license generating unit 109.

The content decryption unit 111 decrypts the encrypted content data acquired from the storage device 200 using the content key acquired from the license reading unit 108. The usage information appending unit 112 appends the usage information conveyed from the license reading unit 108, to the content data decrypted by the content decryption unit 111. The usage information appending unit 112 may append the usage information to a predetermined position of the content data or may embed the usage information in the content data using a watermarking technique or other techniques. In short, the content data are shaped so that the content data are of the same state as the content data stored in the recording medium 20. The reproduction unit 113 reproduces the content data shaped by the usage information appending unit 112. If the reproduction unit 113 does not require the usage information, the content data decrypted by the content decryption unit 111 may be outputted directly to the reproduction unit 113. In such a case, there is no need to provide the usage information appending unit 112.

The secondary-use license generating unit 109 generates secondary-use license data using the content keys and the usage information conveyed from the license reading unit 108. The thus generated secondary-use license data are conveyed to the encryption engine 103 so as to be recorded in the storage device 250 via the encryption engine 103. The secondary-use license data recorded in the storage device 250 is available only for the purpose of reproducing the content data by the reproduction-only device 300b, so that copying is prohibited.

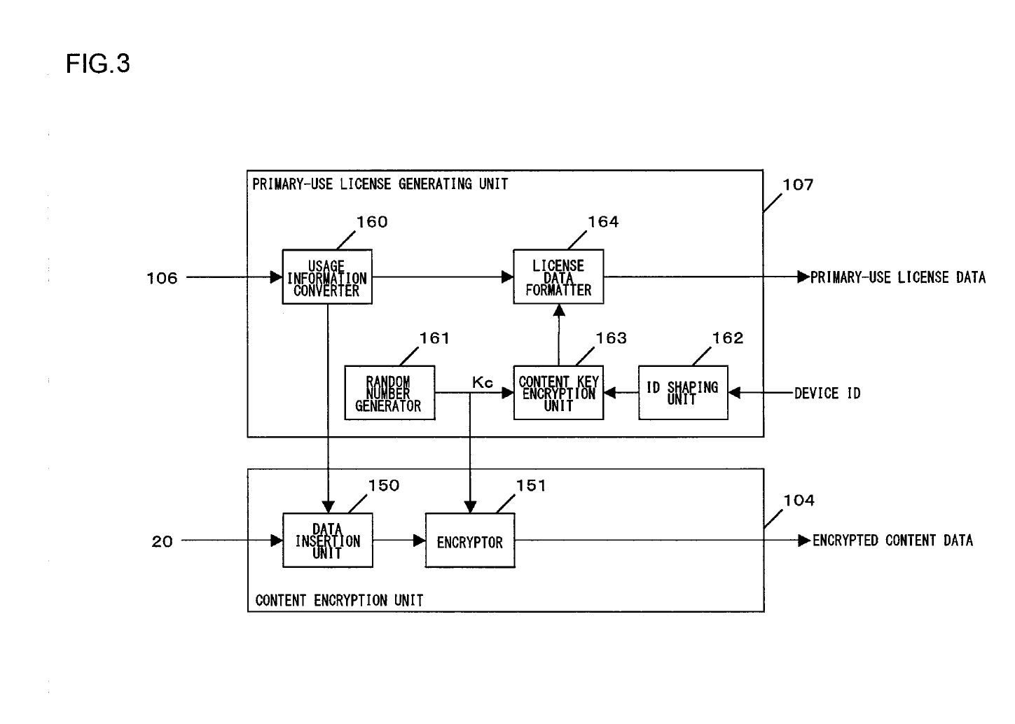

FIG. 3 shows an internal structure of the primary-use license generating unit 107 and the content encryption 104. The primary-use license generating unit 107 includes a usage information converter 160, a random number generator 161, an ID shaping unit 162, a content key encryption unit 163, and a license data formatter 164. The content encryption unit 194 includes a data insertion unit 150 and an encryptor 151.

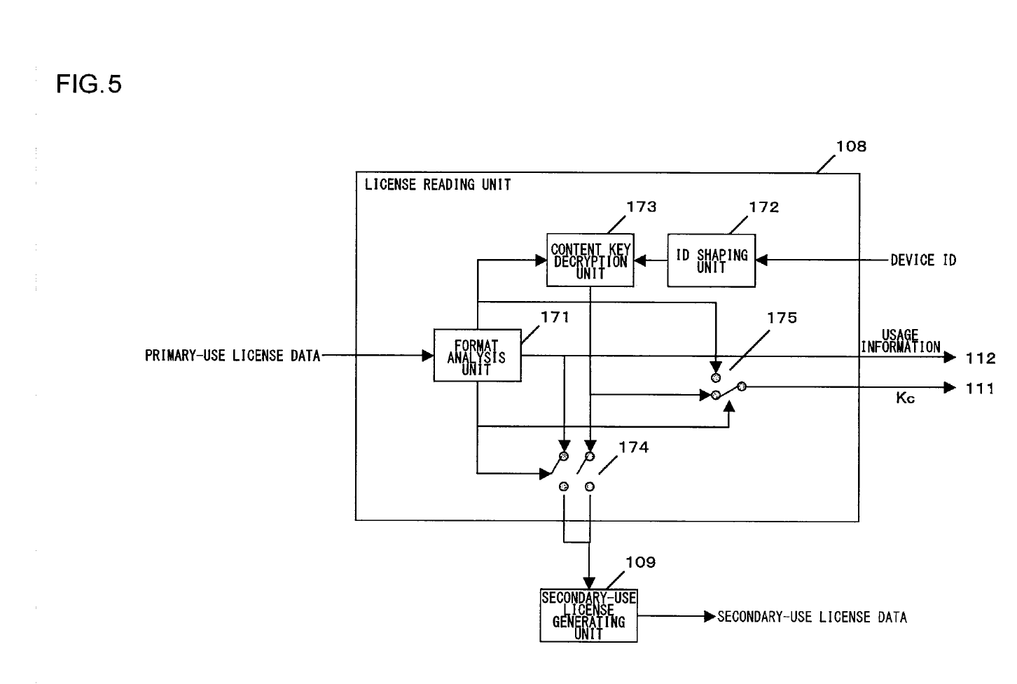

The usage information converter 160 acquires usage information from the usage information detector 106, and converts the data format and the contents of data. If the usage information needs to be inserted into the encrypted content data, the usage information converter 160 will extract information to be inserted therein and convey the extracted information to the data insertion unit 150. Also, the usage information converter 160 converts the usage information so that the format thereof is adjusted to a license data format. The format of license data will be described with reference to FIG. 5.

The random number generator 161 generates a random number used as a content key Kc, and conveys the random number to the content key encryption unit 163 and the encryptor 151. The ID shaping unit 162 acquires the device ID of the recording/reproducing device 100 and shapes it into a format which can be used as an encryption key with which to encrypt the content key in the content key encryption unit 163. The device ID may be fixedly recorded in a BIOS area of the recording/reproducing device 100. The user ID of the recording/reproducing device 100, the ID of a program, such as OS or ripping application running on the recording/reproducing device 100, the device ID of the storage device 200 and so forth may be used instead of the device ID. In short, the ID may be information which can only be known to the user or device permitted to access the content data. The ID shaping unit 162 shapes the acquired device ID so that the ID is adjusted to the bit length of the encryption key in an encryption scheme employed by the content key encryption unit 163. For example, if the number of bits of the device ID is smaller than the bit length of the encryption key, it may be padded with 0's. Conversely, if the number of bits of the device ID is greater than the bit length of the encryption key, necessary bit length may be successively extracted from the beginning, or the necessary bit length may be successively extracted from the ending.

The content key encryption unit 163 encrypts the content key Kc conveyed from the random number generator 161, using the encryption key conveyed from the ID shaping unit 162. The encryption scheme employed in the content encryption unit 163 may be arbitrary. For example, an AES (Advanced Encryption Standard) scheme may be used. The key length in AES may be any one of 128, 192 and 256 bits, and the ID shaping unit 162 shapes the device ID so that the device ID is adjusted to the key length required by the content encryption unit 163. The content key encryption unit 163 may generate the encrypted content key by taking the exclusive-OR of the content key Kc and the device ID. The encrypted content key is conveyed to the license formatter 164.

The AES is a symmetric key cryptosystem. Thus, in order to decrypt the encrypted content key, the device ID is acquired and is shaped the same way as in the ID shaping unit 162 so as to obtain the same common key. As a result, the recording/reproducing device 100 can decrypt the encrypted content key by the use of its own device ID and reproduce the data by decrypting the encrypted content data using the decrypted content key. On the other hand, the other devices cannot acquire the device ID of the recording/reproducing device 100. Thus, even if the other devices have succeeded to copy the encrypted content key, they cannot decrypt the encrypted content data. In this manner, the content key is encrypted using the device ID, so that the content key is restricted to said device only and cannot be used by any other devices.

In the above-described example, the random number generated by the random number generator 161 is set as the content key Kc. As another example, the content key encryption unit 163 performs an encryption operation on the random number generated by the random number generator 161, using the device ID shaped by the ID shaping unit 162, and the thus obtained random number may be set as the content key Kc. In such a case, the random number generated by the random number generator 161 is recorded on the license data, and at the time of reproduction the content key Kc is obtained from the random number and the device ID stored on the license data through the similar operation. In this case, too, the device ID is required to obtain the content key Kc.

The license data formatter 164 shapes the usage information conveyed from the usage information converter 160 and the encrypted content key conveyed from the content key encryption unit 163 into a predetermined format so as to produce the primary-use license data.

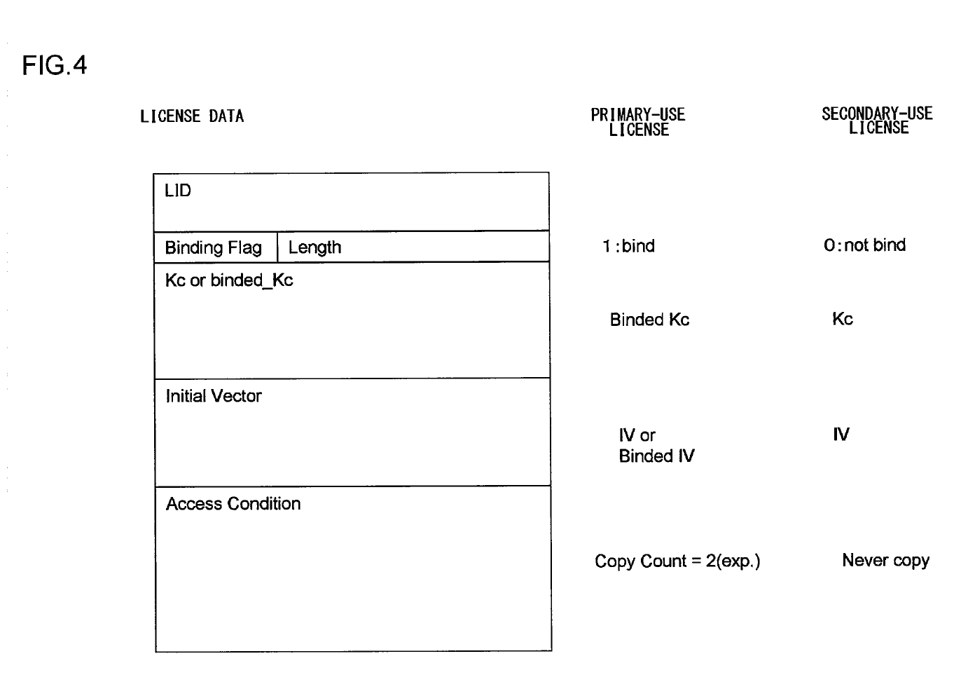

FIG. 4 shows a data structure of license data. The license data contains an “LID” space for storing the IDs of license data, a “Binding Flag” space indicating whether or not a content key is bound to a device ID or the like, a “Kc” space for storing content keys, an “Initial Vector” space for storing an initial vector of a block cipher, and an “Access Condition” space for storing usage control information of license data.

In the “Binding Flag” space, “1 (bind)” indicating that data are restricted (bounded) by a device, namely, encryption is done using the device ID, is stored on the primary-use license data, whereas “0 (not bind)” indicating that the data are not restricted (bounded) by the device is stored on the secondary-use license data. The secondary-use license data are used for reproduction only and therefore cannot be copied or transferred to other devices, so that the content key is not bound to the device ID.

In the “Kc” space, a content key (“binded Kc”) which has been bound to the device ID is stored on the primary-use license data, whereas the content key Kc is stored on the secondary-use license data. As described above, the secondary-use license data cannot be copied or transferred to other devices, so that the content key Kc is not encrypted and stored as it is. If no restriction is imposed on duplication even in the case where the data are primary-use license data, the content key may be directly stored therein without the trouble of b binding the content key to the device ID. Conversely, even if the production of secondary-use license data is prohibited, the content key Kc may also be directly stored therein similarly to the case of the secondary-use license data.

In the base technology, used as a “binded Kc” is the content key which has been encrypted using the device ID. However, data produced using a such a simplified method as taking the exclusive-OR of a content key and a device ID for each bit may be used. In other words, it is only necessary for the content key Kc to be uniquely determined by the “binded Kc” and the device ID.

In the “Initial Vector” space, an initial vector “binded IV” which has been bound (binded) to an initial vector “IV” or device ID is stored on the primary-use license data, whereas the initial vector “binded IV” is stored on the secondary-use license data.

In the “Access Condition” space, “2”, which is a “Copy Count” value, indicating the upper limit of the number of times of duplication is stored on the primary-use license data, whereas “0” (Never Copy) indicating the prohibition of duplication is stored on the secondary-use data. In the base technology, an example is shown where the usage information on duplication is described in the “Access Condition” space. In addition to this, whether the production of secondary-use license data is permitted or not, or the number of times thereof permitted may be specified. If the permitted number of times thereof is to be specified, this value needs to be subtracted every time the secondary-use license data is outputted.

FIG. 5 shows an internal structure of the license reading unit 108. The license reading unit 108 includes a format analysis unit 171, an ID shaping unit 172, a content key decryption unit 173, and switches 174 and 175.

The format analysis unit 171 acquires license data read out from the storage device, via the encryption engine 103, so as to analyze the format thereof. The format analysis unit 171 analyzes the value of each field of the license data shown in FIG. 4, extracts usage information and content keys, and outputs them. At the same time, the format analysis unit 171 controls the switches 174 and 175 in response to the value of each field thereof. The usage information extracted by the format analysis unit 171 is outputted to the usage information appending unit 112 when the content is reproduced, and is outputted to the secondary-use license generating unit 109 via the switch 174 when the content is duplicated. The content keys extracted by the format analysis unit 171 are outputted to the content decryption unit 173 when they are encrypted, and is outputted to the content decryption unit 111 via the switch 175 when they are not encrypted.

The ID shaping unit 172 generates a decryption key used to decrypt the content key which has been encrypted by the encryption key produced by the ID shaping unit 162. As described earlier, when the ID shaping unit 162 has produced encryption keys of a symmetric key cryptosystem by shaping the device ID of the recording/reproducing device 100, the ID shaping unit 172 acquires the device ID of the recording/reproducing device 100 and shapes the device ID thereof through a similar method employed in the ID shaping unit 162 so as to produce the same common key. The content key decryption unit 173 decrypts the encrypted content keys conveyed from the format analysis unit 171, using the decryption keys conveyed from the ID shaping unit 172.

When the content is to be reproduced, the content key Kc which is not encrypted is outputted to an upper terminal of the switch 175 from the format analysis unit 171, and the decrypted content Kc is outputted to a lower terminal of the switch 173 from the content key decryption unit 173. The format analysis unit 171 determines if the content is encrypted or not, by referencing the “Binding Flag” space of the license data. If the content is encrypted, the switch 175 will be connected to the upper terminal thereof, whereas if not, the switch 175 will be connected to the lower terminal thereof. As a result, the content key Kc is outputted to the decryption unit 111.

When the content is to be copied, the usage information is outputted to a left-side terminal of the switch 174 from the format analysis unit 171, and the decrypted content Kc is outputted to a right-side terminal of the switch 174 from the content key decryption unit 173. The format analysis unit 171 determines if the copying of the content key is permitted or not, by referencing the “Access Condition” space of the license data. If the copying thereof is permitted, the switch 174 will be turned on and the usage information and the content keys will be outputted to the secondary-use license generating unit 109. If the copying is prohibited, the switch 174 will be turned off and the output of the usage information and the content keys will be prohibited.

The secondary-use license generating unit 109 produces the secondary-use license data having the data structure shown in FIG. 4, using the acquired usage information and content keys. The thus produced secondary-use license data are recorded in the storage device 250 via the encryption engine 103.

In the examples shown in FIG. 3 and FIG. 4, at the time of reproduction of the primary-use license data the content key Kc is encrypted using the common key generated based on the device ID, and at the time of utilization of the primary-use license data the content key Kc is obtained by decrypting the “binded Kc” using the common key generated based on the device ID. As another example, the content key encryption unit 163 in the primary-use license generating unit 107 may perform a predetermined operation on the content key Kc using the device ID or the like so as to set this data converted from the content key as “binded Kc”. The operation may be exclusive-OR, logical sum (OR), logical product (AND), NOT-OR, or negative AND implemented bit by bit. In such a case, the content key decryption unit 173 in the license reading unit 108 can obtain the content key Kc by performing the inverse operation of the operation performed by content key encryption key 163 on the “binded Kc” obtained from the primary-use license data using the device ID.

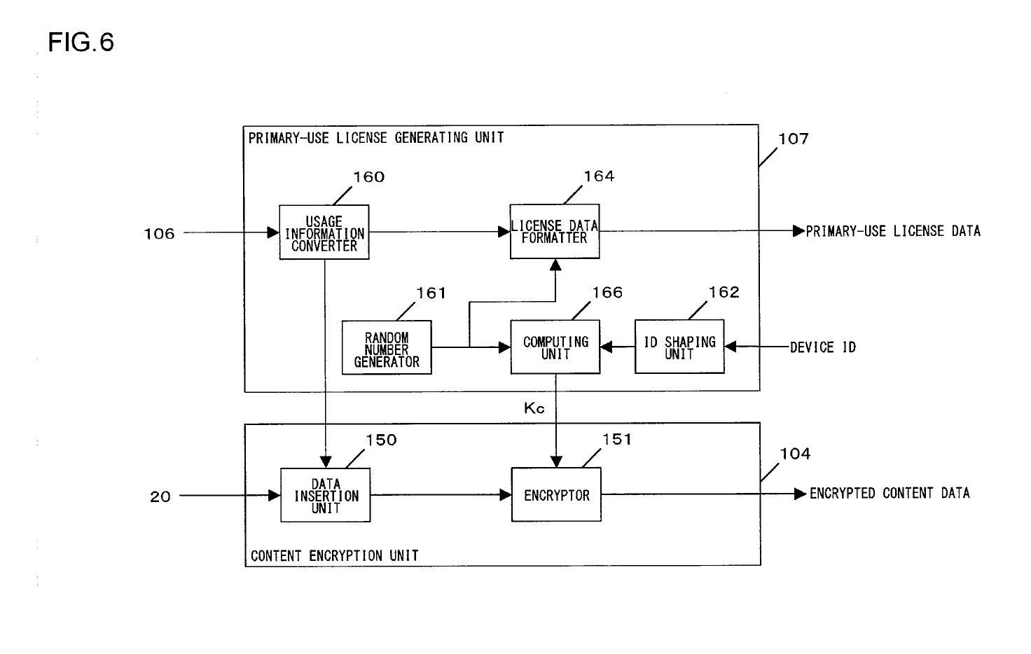

A description is now given of another exemplary method for binding the content key to the device ID. FIG. 6 shows another exemplary structure of the primary-use license generating unit 107. Compared with the structure of the primary-use license generating unit 107 shown in FIG. 3, the primary-use license generating unit 107 shown in FIG. 6 includes a computing unit 166 in substitution for the content key encryption unit 163. The components thereof other than the computing unit 166 are the same as those of the primary-use license generating unit 107 shown in FIG. 3.

In the example shown in FIG. 6, the random number that the random number generator 161 has generated is conveyed to the license data formatter 164 so as to be stored on the primary-use license data. That is, this random number is treated as the “binded Kc”. The random number is conveyed to the computing unit 166, too. The computing unit 166 performs a predetermined operation using the device ID shaped by the ID shaping unit 162, on the random number conveyed, so as to generate the content key Kc. That is, the content key Kc cannot be obtained unless the device ID is known.

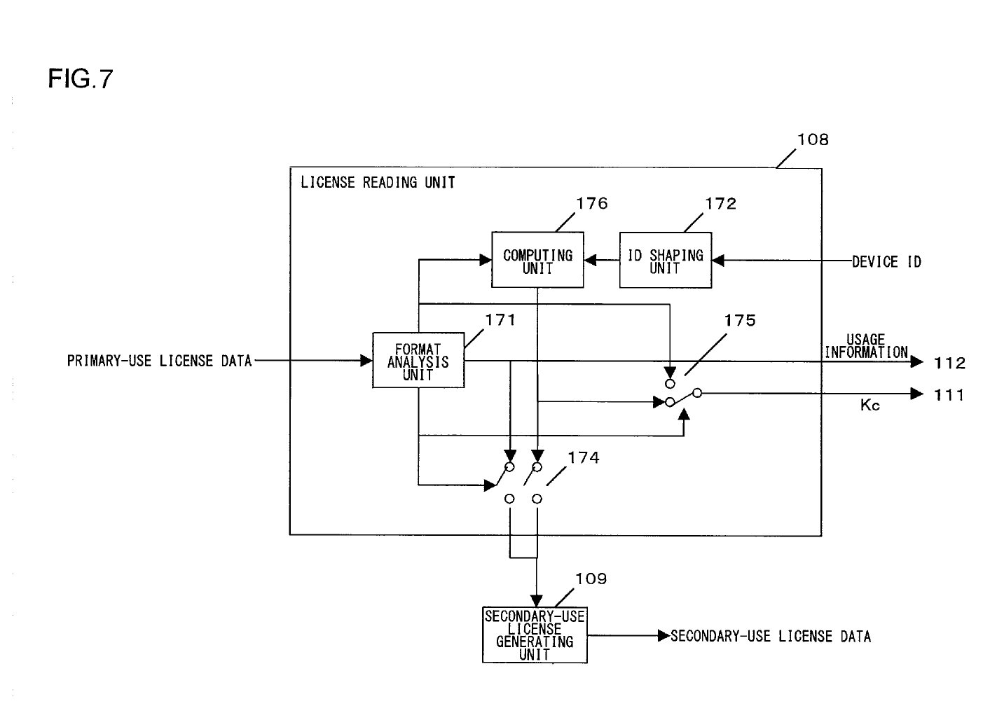

FIG. 7 shows another exemplary structure of the license reading unit 108. This license reading unit 108 and the primary-use license generating unit 107 shown in FIG. 6 come in pairs; and if the structure as shown in FIG. 6 is employed as the primary-use license generating unit 107, the structure as shown in FIG. 7 will be employed as the license reading unit 108. Compared with the structure of the license reading unit 108 shown in FIG. 5, the license reading unit 108 shown in FIG. 7 includes a computing unit 176 in substitution for the content key decryption unit 173. The components thereof other than the computing unit 176 are the same as those of the license reading unit 108 shown in FIG. 5.

In the example of FIG. 7, the “binded Kc” conveyed to the computing unit 176 from the format analysis unit 171 is a random number produced by the random number generator 161 in the primary-use license generating unit 107. Using the device ID shaped by the ID shaping unit 172, the computing unit 176 performs the same operation as that used in the computing unit 166 of the primary-use license generating unit 107, on the random number conveyed from the format analysis unit 171, so as to obtain the content key Kc. The operation performed by the computing units 166 and 176 may be arbitrary and may be, for example, exclusive-OR, logical sum (OR), logical product (AND), NOT-OR, negative AND, or the like. The computing units 166 and 176 may be an encrypter using an encryption scheme such as AES and/or a decryptor. In such a case, the device ID may be thought of as an encryption key or a decryption key, so that the random number may be subjected to an operation for encrypting or decrypting the random number.

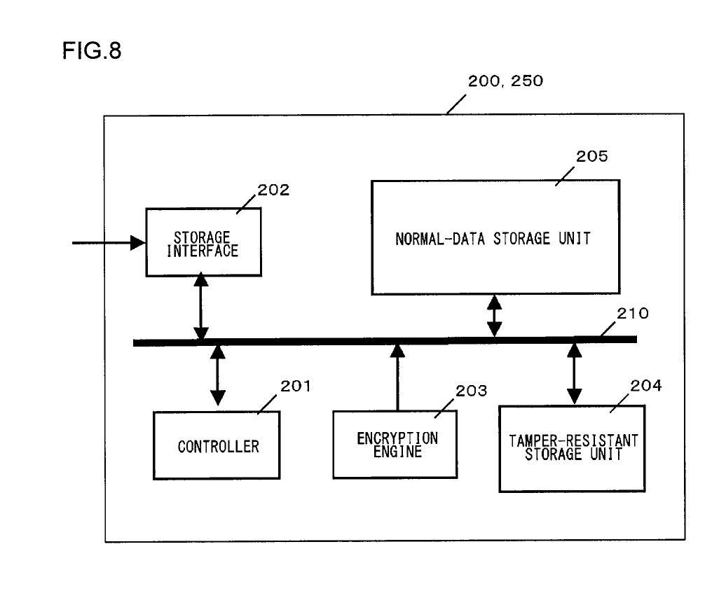

FIG. 8 shows an internal structure of the storage devices 200 and 205. The storage devices 200 and 205 each principally includes a controller 201, a storage interface 202, an encryption engine 203, a tamper-resistant storage unit 204, a normal-data storage unit 205, and a data bus 210 for electrically connecting these components to each other.

The storage interface 202 controls input/output of data to/from the recording/reproducing device 100. The encryption engine 203 controls encrypted communication so that confidential data, such as license data containing the content key, can be inputted to and outputted from the recording/reproducing apparatus 100. The normal-data storage unit 205 is a normal-data storage area designed to record the encrypted content data, normal data, and the like. The tamper-resistant storage unit 204 is a confidential-data storage area designed to record confidential data such as the license data containing the content key. The normal-data storage unit 205 is so structured that data are inputted thereto and outputted therefrom by direct access from the outside. On the other hand, the tamper-resistant storage unit 204 is so structured that data cannot be inputted or outputted unless the data pass through the encryption engine 203. The controller 201 performs overall control of these components of the storage device 200.

A description is now given of an encryption communication carried out when the license data are recoded in the storage device 100 or 250. As shown hereunder, every time the license data is recorded, the storage device in which the license data are to be recorded is authenticated and the license data are recorded on a valid storage device only. Hence, even if the storage device in which the license data are to be recorded is a removable storage device, unauthorized copying can be prevented. Though a description will be given hereinbelow of a case where the license data are recorded in the storage device 200, the same applies to the case where the license data are recorded in the storage device 250.

A description is now given of keys used in the base technology. In the base technology, all keys are represented by a string of characters starting from the capital letter “K”. If the second character is any of small letters “c”, “s” and “b”, it will represent a symmetrical key (common key). More specifically, “c” is a challenge key and represents a temporal symmetrical key produced by the sender of license data. “s” is a session key and represents a temporal symmetrical key produced by the sender of license data. “b” is a bus key and represents a temporal symmetrical key produced by the sender of the license data. If the second character is the capital letter “P”, it will represent a public key of a public key encryption scheme. There is always a secret key that corresponds to this public key, and the secret key is described in such a manner that the second character namely the capital letter “P” is removed from the public key description.

If the string of characters indicating a key contains a small letter “d”, such a key will be one given per device group. If the string of characters indicating a key contains a small letter “p”, such a key will be one given per device. Each of those keys is given as a pair of a public key and secret key, and a public key KPdx given per group is given as a public key certificate C[KPdx] with electronic signature.

A character described at the end of the string of characters indicating the key, for example, “2” in the public key KPd2 is a code to identify the encryption engine from which said key has been given. In the base technology, when the key is provided by a specified encryption engine, it is denoted by a number such as “1”, “2” or “3”. When the key is provided by an unknown or unspecified encryption engine which is other than the aforementioned encryption engine, it is denoted by an alphabetic character such as “x” or “y”. In the base technology, an identification number mark “1” is used for the encryption engine 103 in the recording/reproducing device 100 when the license data are to be written; an identification number mark “2” is used for the encryption engine 203 in the storage device 200 then; and an identification number mark “3” is used for the encryption engine 103 in the recording/reproducing device 100 when the license data are to be read out.

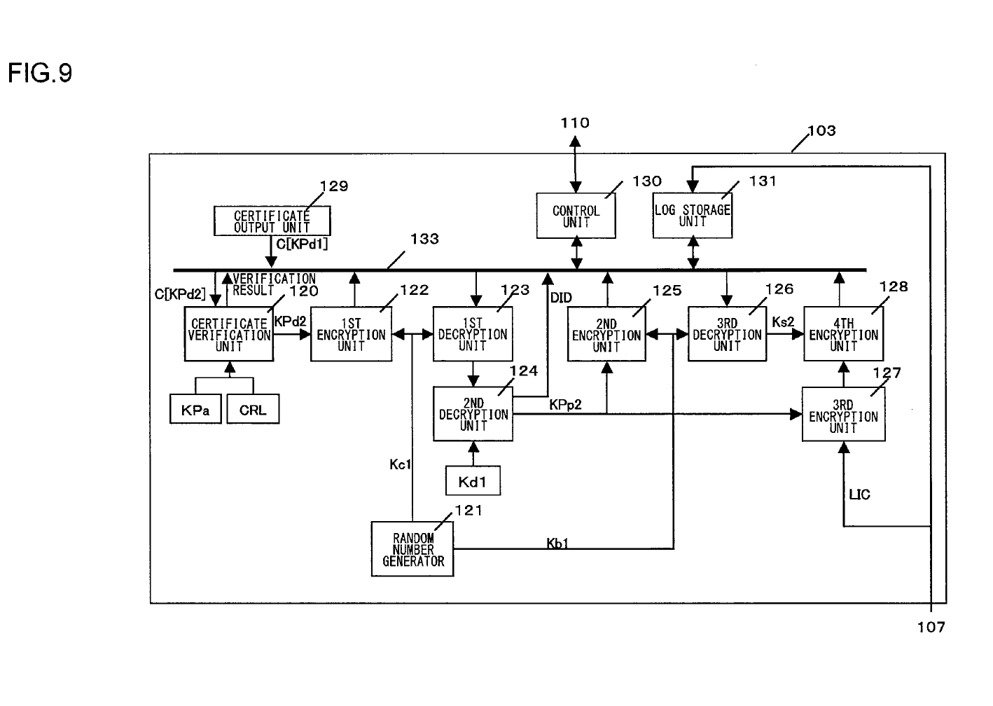

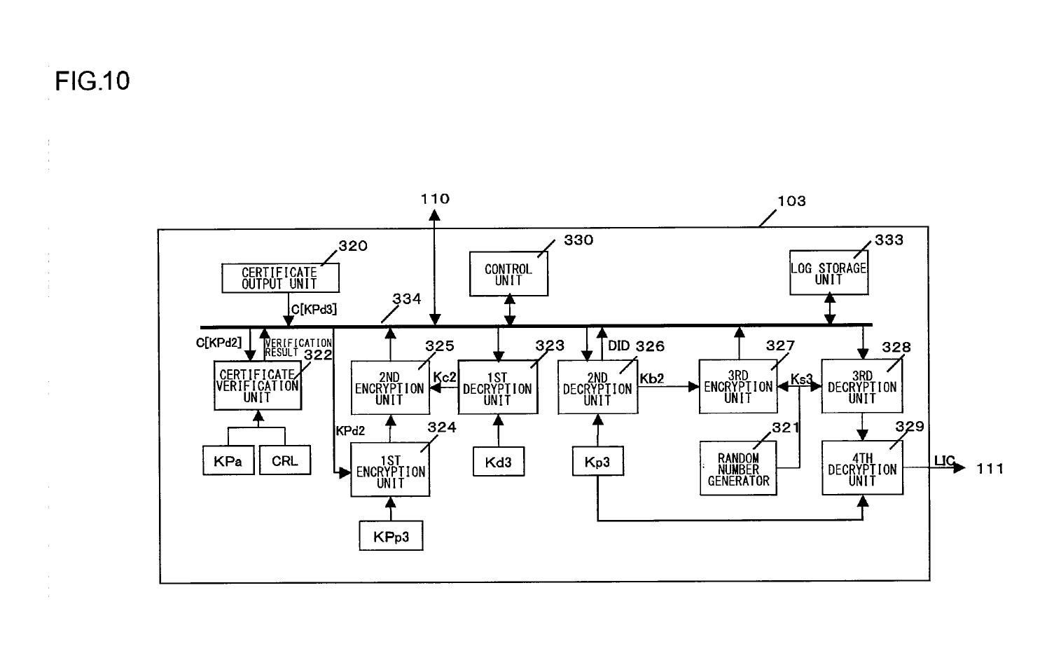

FIG. 9 shows an internal structure of the encryption engine 103 in the recording/reproducing device 100 shown in FIG. 2. FIG. 9 shows only the structure used when the license data are sent to the storage device 200. A structure used when the license data are received from the storage device 200 is shown in FIG. 10. The encryption engine 103 includes a certificate verification unit 120, a random number generator 121, a first encryption unit 122, a first decryption unit 123, a second decryption unit 124, a second encryption unit 125, a third decryption unit 126, a third encryption unit 127, a fourth decryption unit 128, a certificate output unit 129, a control unit 130, a log storage unit 131, and a local bus 133 for electrically connecting at least part of these components to each other.

The certificate verification unit 120 verifies a certificate C[KPd2] acquired from the storage device 200. The certificate C[KPd2] is comprised of plain text information (hereinafter referred to as “certificate body”) containing the public key KPd2 and a digital signature appended to the certificate body. The digital signature is data created as follows. The certificate body is subjected to an operation using a hash function (this computation is called a hash operation). The result thus obtained is encrypted using a root key Ka. The root key Ka is a non-public key which is strictly managed by a certificate authority and therefore the root key Ka is a secret key of the certificate authority. The certificate verification unit 120 stores a verification key KPa which pairs with this root key Ka. This verification key Kpa is a public key with which the validity of a certificate is verified. The verification of the certificate is determined by the validity and the effectiveness of the certificate.

The validity of the certificate is verified by comparing the computational result of applying the hash function to the certificate body of a certificate to be verified against the result of decrypting the electronic signature with the verification key KPa. When both results coincide, it is determined that the certificate is valid. The certificate verification unit 120 stores a certificate revocation list (CRL) which lists certificates verified as invalid, and determines that a certificate to be verified is valid if it is not contained in this CRL. A processing in which the validity and the effectiveness of certificates is determined in this manner so as to approve valid certificates will be called “verification”.

If the verification is successful, the certificate verification unit 120 will retrieve the public key KPd2 of the storage device 200 and convey it to the first encryption unit 122, thus providing information of the verification result thereof. If the verification fails, the certificate verification unit 120 will output a notification of verification error.

The certificate output unit 129 outputs a certificate C[KPd1] of the recording/reproducing device 100. This certificate is comprised of a certificate body containing the public key KPd1 of the recording/reproducing device 100 and a digital signature appended to the certificate body. Similar to the certificate of the storage device 200, the digital signature is encrypted by the root key Ka of the certificate authority.

The random number generator 121 generates challenge keys Kc1 and bus keys Kb1 temporarily used for encryption communication between the recording/reproducing device 100 and the storage device 200. Every time the encryption communication is performed a challenge key Kc1 is produced, so that the possibility of the challenge key Kc1 being cracked can be minimized. The challenge key Kc1 generated is conveyed to the first encryption unit 122 and the first decryption unit 123, whereas the bus key Kb1 is conveyed to the second decryption unit 125 and the third decryption unit 126.

In order to notify the storage device 200 of the challenge key Kc1, the first encryption unit 122 encrypts the challenge key Kc1 using the public key KPd2 of the storage device 200 retrieved by the certificate verification unit 120, thereby producing an encrypted challenge key E(KPd2, Kc1). Then the encrypted challenge key E(KPd2, Kc1) is combined with the certificate C[KPd1] outputted from the certificate output unit 129 so as to become first challenge information E(KPd2, Kc1)∥C[KPd1].

Here, the symbol “∥” indicates data concatenation. For example, E(KPd2, Kc1)∥C[KPd1] denotes a data string where the encrypted challenge key E(KPd2, Kc1) is combined with C[KPd1] in a juxtaposed manner. E indicates an encryption function, whereas E(KPd2, Kc1) represents a data string where the challenge key Kc1 is encrypted using the public key KPd2.

The first decryption unit 123 decrypts the data encrypted with the challenge key Kc1. A public key KPp2 that pairs with a secret key Kp2 stored separately and secretly inside the storage device 200 and second challenge information E(Kc1, E(KPd1, KPp2∥DID)) where unique identification information DID with which the storage device 200 can be uniquely identified is encrypted are supplied from the storage device 200. Hence, the first decryption unit 123 decrypts the second challenge information using the challenge key Kc1 produced by the random number generator 121 so as to retrieve encrypted data E(KPd1, KPp2∥DID).

The second decryption unit 124 decrypts the data encrypted with its own public key KPd1, using the secret key Kd1 secretly stored therein. The second decryption unit 124 decrypts the encrypted data E(KPd1, KPp2∥DID) conveyed from the first decryption unit 123, and retrieves the public key KPp2 and the identification information DID of the storage device 200.

In order to inform the storage device 200 about the bus key Kb1, the second encryption unit 125 encrypts the bus key Kb1, using a public key KPp2 of the storage device 200, so as to produce an encrypted bus key E(KPp2, Kb1). The encrypted bus key is provided to the storage device 200 as connection information E(KPp2, Kb1).

The third decryption unit 126 decrypts the data encrypted with the bus key Kb1. A session key Ks2 issued by the storage device 200 is supplied, as session information E(Kb1, Ks2), from the storage device 200. Thus, the third decryption unit 126 decrypts the session information using the bus key Kb1 generated by the random number generator 121 so as to retrieve the session key Ks2. The session key Ks2 retrieved is conveyed to the fourth decryption unit 128.

The third encryption unit 127 acquires the license data LIC generated by the primary-use license generating unit 107 or the secondary-use license generating unit 109, and encrypts said license data LIC using public key KPp2 of the storage device 200 so as to generate E(KPp2, LIC). Then E(KPp2, LIC) is conveyed to the fourth encryption unit 128.

The fourth encryption unit 128 further encrypts E(KPp2, LIC) conveyed from the third encryption unit 127, using the session key Ks2 issued by the storage device 200, so as to generate encrypted license data E(Ks2, E(KPp2, LIC)).

The log storage unit 131 relates the identification information DID conveyed from the second decryption unit 124 and the license data LIC outputted to the storage device 200 to the address data ADR of the storage device 200 scheduled to be recorded, and stores them statically. Note that the license data LIC stored in the log storage 131 are outputted, only in the encrypted form, to an access that has undergone a predetermined procedure.

In accordance with instructions from the controller 101 of the recording/reproducing device 100, the control unit 130 mediates the control of components inside the encryption engine 103 and the input and output of data between the components inside and those outside the encryption engine 103. Note that the connection indicating the control of each of the internal components performed by the control unit 130 is omitted in FIG. 9.

As shown in FIG. 9, the structure according to the base technology is such that the encryption engine 103 cannot exchange data with the outside unless the data pass through the control unit 130. Though a variety of modes of connecting each of the components are conceivable, the structure according to the base technology is such that each key used within the encryption engine, such as the challenge key Kc1 generated by the random number generator 121, the session key Ks2 received from the storage device 200, or its own secret key Kd1, is not available to the outside. This prevents the leakage of each key used within the encryption engine 103 by way of the other components or the like of the recording/reproducing device 100 to the outside, thus improving the security.

FIG. 10 shows an internal structure of the encryption engine 103 in the recording/reproducing device 100 shown in FIG. 2. FIG. 10 shows only the structure used when the license data are received from the storage device 200. The encryption engine 103 includes a certificate output unit 320, a random number generator 321, a certificate verification unit 322, a first decryption unit 323, a first encryption unit 324, a second encryption unit 325, a second decryption unit 326, a third encryption unit 327, a third decryption unit 328, a fourth decryption unit 329, a control unit 330, a log storage unit 333, and a local bus 334 for electrically connecting at least part of these components to each other.

The certificate output unit 320 outputs a certificate C[KPd3] of the recording/reproducing device 100. The certificate may be stored in the certificate output unit 320 or may be stored in a not-shown certificate storage and read out of this storage. This certificate is comprised of a certificate body containing the public key KPd3 of the recording/reproducing device 100 and a digital signature appended to the certificate body. Similar to the certificate of the storage device 200, the digital signature is encrypted by the root key Ka of the certificate authority. Note that the certificate C[KPd3] may be the same as the certificate C[KPd1].

The random number generator 321 generates a session key Ks3 temporarily used for encryption communication between the recording/reproducing device 100 and the storage device 200. The session key Ks3 generated is conveyed to the third encryption unit 327 and the third decryption unit 328.

The certificate verification unit 322 verifies the certificate C[KPd2] of the storage device 200. The details of the verification are discussed hereinabove.

The first decryption unit 323 decrypts the data encrypted with the public key KPd3, using a secrete key Kd3. At the time of reproduction, a challenge key Kc2 issued by the storage device 200 is encrypted with the public key KPd3 of the recording/reproducing device 100 and supplied from the storage device 200. Thus, the first decryption unit 323 decrypts this using its own secret key Kd3 so as to retrieve the challenge key Kc2. The thus retrieved challenge key Kc2 is conveyed to the second encryption unit 325.

The first encryption unit 324 encrypts data using the public key KPd2 retrieved from the certificate C[KPd2] of the storage device 200. An encrypted unique public key E(KPd2, KPp3) is produced in order to inform the storage device 200 about a public key KPp3 that pairs with a secret key Kp3 assigned uniquely to the recording/reproducing device 100 wherein the secret key Kp3 is secretly stored therein. The encrypted unique public key E(KPd2, KPp3) thus produced is conveyed to the second encryption unit 325.

The second encryption unit 325 encrypts data using the challenge key Kc2 retrieved by the first decryption unit 323. The encrypted unique public key E(KPd2, KPp3) conveyed from the first encryption unit 324 is encrypted so as to produce second challenge information E(Kc2, E(KPd2, KPp3)).

The second decryption unit 326 decrypts the data encrypted with the public key KPp3. Connection information E(KPp3, Kb2∥DID) is decrypted using the secrete key Kp3 that pairs with the public key KPp3 so as to retrieve the bus key Kb2 issued by the storage device 200 and the identification information DID with which a storage device can be uniquely identified.

To supply the session key Ks3 produced by the random number generator 321 to the storage device 200, the third encryption unit 327 encrypts the session key Ks3 using the bus key Kb2, issued by the storage bus 200, which has been retrieved by the second decryption unit 326, and thereby produces session information E(Kb2, Ks3).

The third decryption unit 328 decrypts the data encrypted with the session key Ks3. The license data LIC is supplied, from the storage device 200, as license data E(Ks3, E(KPp3, LIC)) doubly encrypted with the public key KPp3 and the session key Ks3. Thus, the third decryption unit 328 performs decryption using the session key Ks3 produced by the random number generator 321, and conveys license data E(KPp3, LIC) derived from the decryption, to the fourth decryption unit 329.

The fourth decryption unit 329 decrypts the data encrypted with the public key KPp3. The fourth decryption unit 329 decrypts the encrypted license data E(KPp3, LIC), which has resulted from the decryption performed by the third decryption unit 328, using the secret key Kp3 that pairs with the public key Pp3, so as to retrieve the license data LIC.

The log storage unit 333 relates the identification information DID conveyed from the second decryption unit 326 and the identification information LID of the license data LIC scheduled to be received from the storage device 200 to the address data ADR of the storage device 200 in which said license data are stored, and stores them statically. Once the license data LIC is used, the LID and ADR of this license data is deleted.

In accordance with instructions from the controller 101 of the recording/reproducing device 100, the control unit 330 mediates the control of components inside the encryption engine 103 and the input and output of data between the components inside and those outside the encryption engine 103. Note that the connection indicating the control of each of the internal components performed by the control unit 330 is omitted in FIG. 10.

Though a variety of modes of connecting each of the components are also conceivable in the encryption engine 103 shown FIG. 10, the structure according to the base technology is such that the encryption engine 103 cannot exchange data with the outside unless the data pass through the control unit 330. This prevents keys used within the encryption engine 103, such as the session key Ks3 produced by the random number generator 321, the secret keys Kd3 and Kp3 that pair with the public keys, the bus key Kb2 received from the storage device 200 and the challenge key Kc2, from being leaked to the outside.

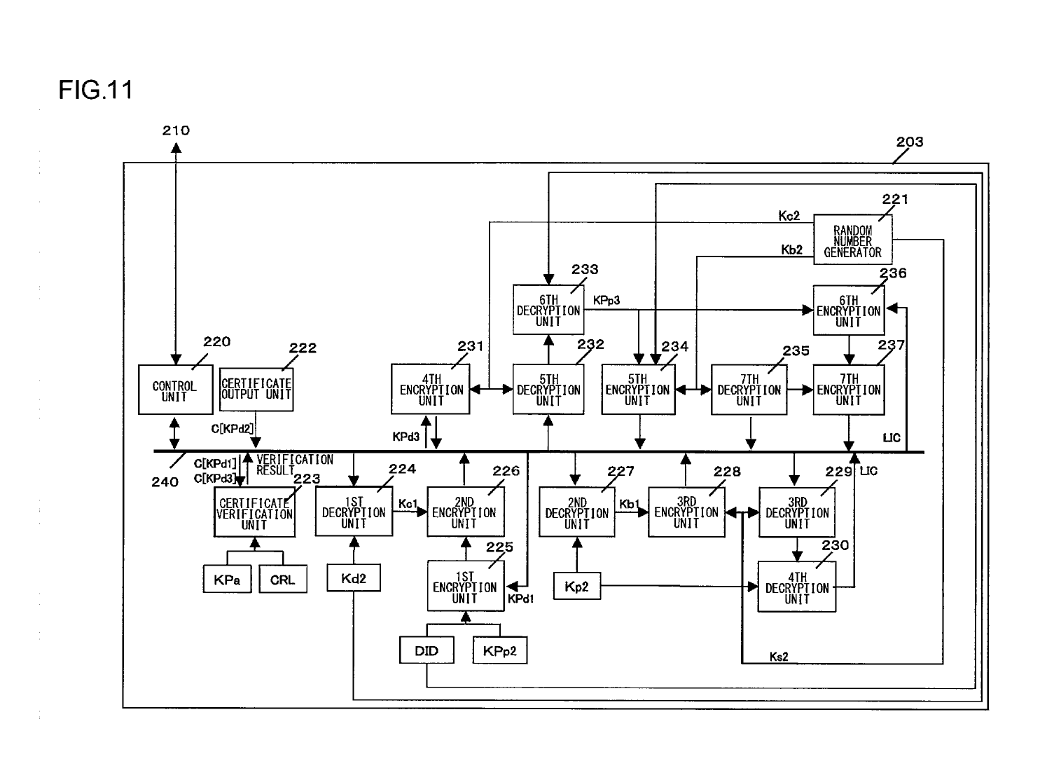

FIG. 11 shows an internal structure of the encryption engine 203 in the storage device 200 shown in FIG. 8. The encryption engine 203 includes a control unit 220, a random number generator 221, a certificate output unit 222, a certificate verification unit 223, a first decryption unit 224, a first encryption unit 225, a second encryption unit 226, a second decryption unit 227, a third encryption unit 228, a third decryption unit 229, a fourth decryption unit 230, a fourth encryption unit 231, a fifth decryption unit 232, a sixth decryption unit 233, a fifth decryption unit 234, a seventh decryption unit 235, a sixth encryption unit 236, a seventh decryption unit 237, and a local bus 240 for electrically connecting at least part of these components to each other.

In accordance with instructions from the controller 201 of the storage device 200, the control unit 220 mediates the control of components inside the encryption engine 203 and the input and output of data between the components inside and those outside the encryption engine 203.

Through a random number operation, the random number generator 221 generates the session key Ks2, the challenge key Kc2 and the bus key Kb2 used temporarily between the storage device 200 and the recording/reproducing device 100. The use of each key will be discussed later.

The certificate output unit 222 outputs the certificate C[KPd2] of the storage device 200. The certificate may be stored in the certificate output unit 222. Or the certificate may be stored on a predetermined storage area of the storage device 200, for example, in the tamper-resistant storage unit 204, and may be read out therefrom. The certificate is comprised of a certificate body containing the public key KPd2 of the storage device 200 and a digital signature appended to the certificate body. The digital signature is encrypted by the root key Ka of the certificate authority.

The certificate verification unit 223 verifies certificates provided from the outside. More specifically, the certificates C[KPd1] and C[KPd3] acquired from the recording/reproducing device 100 are verified using the verification key KPa. The details of verification are described as above.

The first decryption unit 224 decrypts the data encrypted with its own public key KPd2. More specifically, since at the time of recording the challenge key Kc1 issued by the recording/reproducing device 100 is encrypted using the public key KPd2 of the storage device 200 and supplied from the recording/reproducing device 100, this encrypted challenge key Kc1 is decrypted using its own secret key Kd2 and then the challenge key Kc1 is retrieved. The thus retrieved challenge key Kc1 is conveyed to the second encryption unit 226.

The first encryption unit 225 encrypts data using the public key KPd1 of the recording/reproducing device 100. More concretely, encrypted individual information E(EPd1, KPp2∥DID) is produced. This encrypted individual information E(KPd1, KPp2∥DID) is obtained by encrypting individual information where the public key KPp2 stored separately in each storage device 200 and the identification information DID to identify the storage device are combined together. The public key KPd1 of the recording/reproducing device 100 used here is retrieved from within the certificate C[KPd1] of the storage device 200 and conveyed via the local bus 240.

The second encryption unit 226 encrypts data using challenge key Kc1. More specifically, the encrypted individual information E(KPd1, KPp2∥DID) received from the first encryption unit 225 is encrypted using the challenge key Kc1 and then the second challenge information E(Kc1, E(KPd1, KPp2)∥DID)) is produced.

The second decryption unit 227 decrypts the data encrypted with its own public key KPp2. The second decryption unit 227 decrypts the connection information E(KPp2, Kb1) supplied from the recording/reproducing device 100, using the secret key Kp2 that pairs with the public key KPp2, and conveys the retrieved key Kb1 to the third encryption unit 228.

The third encryption unit 228 encrypts data using the bus key Kb1. More specifically, the session key Ks2 generated by the random number generator 221 is encrypted with the bus key Kb1 and then the session information E(Kb1, Ks2) is produced.

The third decryption unit 229 decrypts the data encrypted with the session key Ks2 produced by the random number generator 221. More specifically, the license data LIC are received from the recording/reproducing device 100, as E(Ks2, E(KPp2, LIC)) doubly encrypted with the public key KPp2 and the session key Ks2, and are decrypted using the session key Ks2 and then the result of decryption is conveyed to the fourth decryption unit 230.

The fourth decryption unit 230 decrypts the data encrypted with its own public key KPp2. The license data E(KPp2, LIC) conveyed from the third decryption unit 229 is decrypted using its own secret key Kp2 that pairs with the public key KPp2, and then the license data LIC are retrieved.

The thus retrieved license data LIC are supplied to the data bus 210 via the local bus 240 and the control unit 220 and are stored in the tamper-resistant storage unit 204 according to the instruction from the controller 201.

The fourth decryption unit 231 encrypts the data with the public key KPd3 of a license, using device 300. More specifically, when the license data are supplied to the license using device 300, the challenge key Kc2 issued by the random number generator 221 is encrypted using the public key KPd3 retrieved from the certificate C[KPd3] received from the recording/reproducing 100, so that an encrypted challenge key E(KPd3, Kc2) is produced. The encrypted challenge key E(KPd3, Kc2) produced as above is conveyed to the control unit 220 via the local bus 240. The control unit 220 combines this encrypted challenge key E(KPd3, Kc2) with its own certificate C[KPd2] outputted from the certificate output unit 222 so as to produce first challenge information E(KPd3, Kc2)∥C[KPd2] and output this first challenge information to the recording/reproducing device 100.

The fifth decryption unit 232 decrypts the data encrypted with the challenge key Kc2 issued by the random number generator 221. The second challenge information E(Kc2, E(KPd2, KPp3)) received from the recording/reproducing device 100 is decrypted using the challenge key Kc2 produced by the random number generator 221, and the encrypted individual public key E(KPd2, KPp3) thus retrieved is conveyed o the sixth decryption unit 233.

The sixth decryption unit 223 decrypts the data encrypted with its own public key KPd2. More specifically, the encrypted individual public key E(KPd2, KPp3) conveyed from the fifth decryption unit 232 is decrypted using its own secret key Kd2, so that the public key KPp3 of the recording/reproducing device 100 is retrieved. The thus retrieved public KPp3 is conveyed to the fifth encryption unit 234 and the sixth encryption unit 236.

The fifth encryption unit 234 encrypts data using the public key KPp3 of the recording/reproducing device 100. The bus key Kb2 produced by the random number generator 221 is combined with its own identification information DID. By encrypting such combined data, the connection information E(KPp3, Kb2∥DID) is produced.

The seventh decryption unit 235 decrypts the data encrypted with the bus key Kb2. By decrypting the session information E(Kb2, Ks3) supplied from the recording/reproducing device 100, the session key Ks3 issued by the recording/reproducing device 100 is retrieved and the thus retrieved session key Ks3 is conveyed to the seventh encryption unit 237.

The sixth encryption unit 236 encrypts data using the public key KPp3 of the recording/reproducing device 100. When license data are to be supplied to the recording/reproducing device 100, the license data LIC are encrypted using the public key KPp3 received from the recording/reproducing device 100. The license data LIC are read out from the tamper-resistant storage unit 204 according to the instructions from the controller 201, and are conveyed to the sixth encryption unit 235 via the control unit 220 and the local bus 240. Here, the encrypted license data E(KPp3, LIC) is conveyed to the seventh encryption unit 237.

The seventh encryption unit 237 encrypts data using the session key Ks3 issued by the recording/reproducing device 100. More specifically, the license data E(KPp3, LIC) encrypted by the sixth encryption unit 236 is further encrypted using the session key Ks3, so that encrypted license data E(Ks3, E(KPp3, LIC)) is produced.

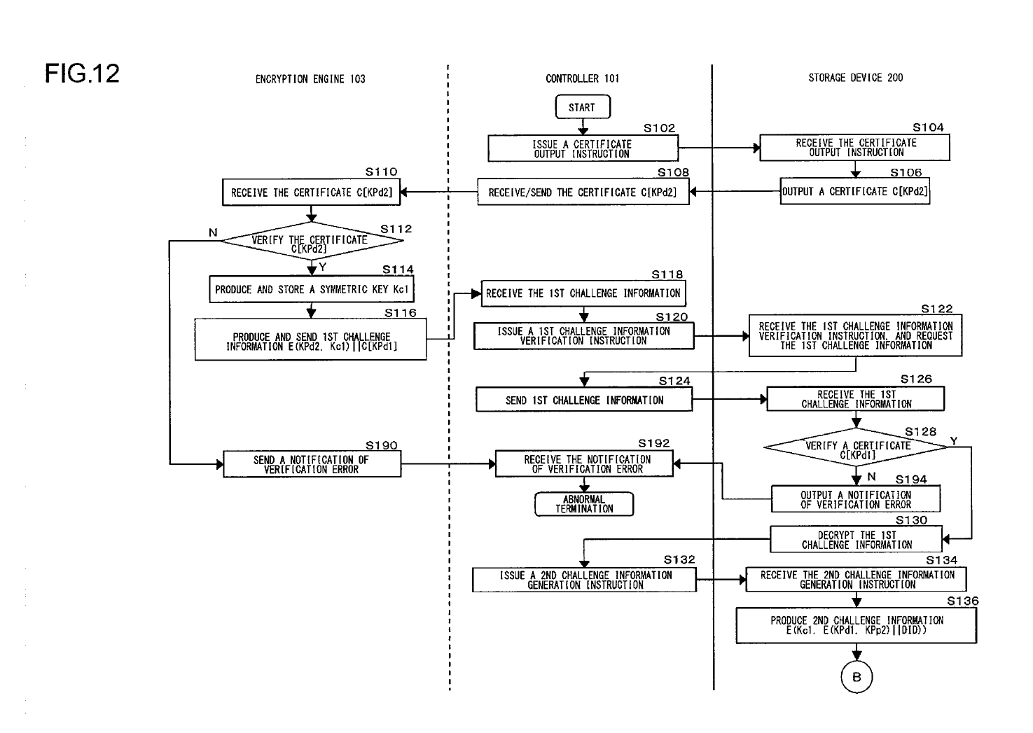

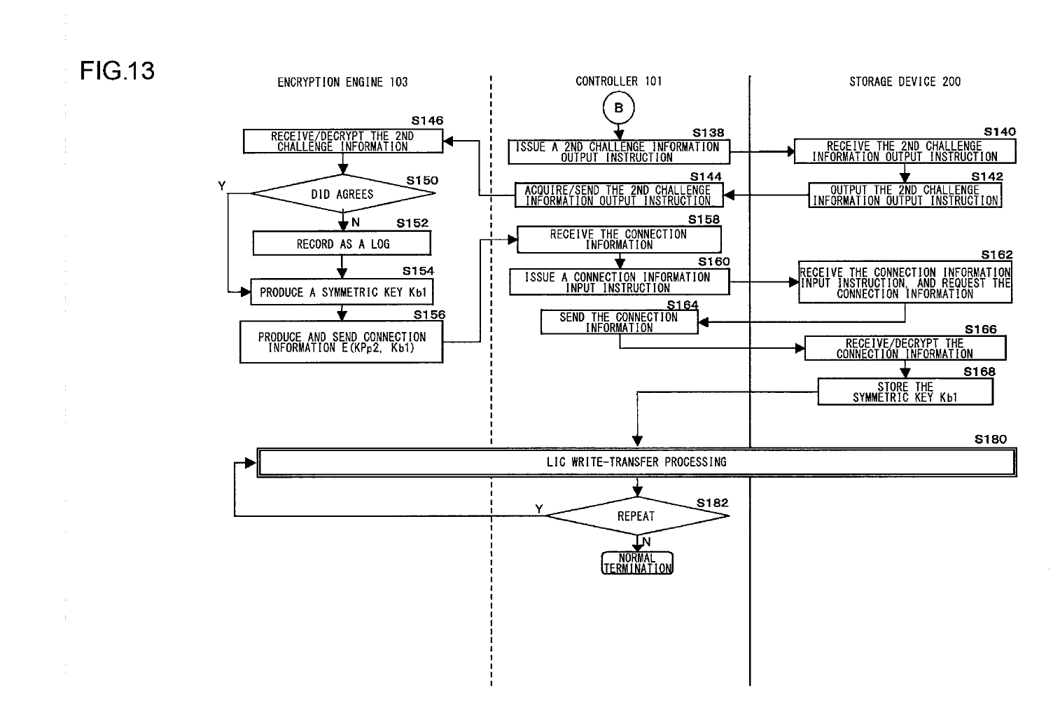

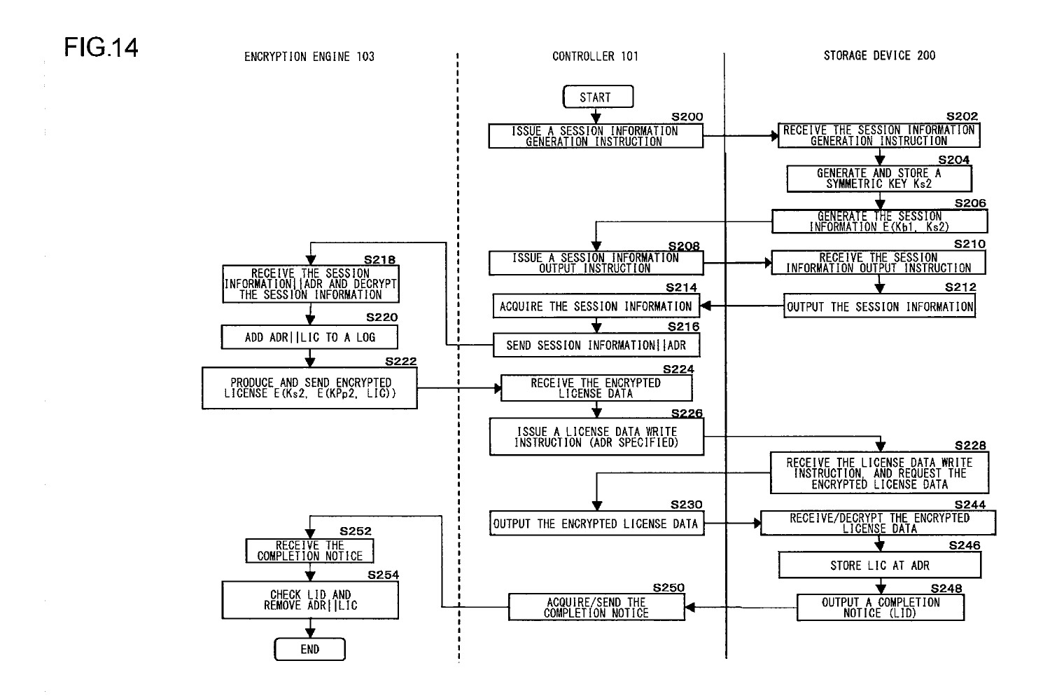

FIG. 12 and FIG. 13 show steps performed until the recording/reproducing device 100 records the license data LIC in the storage device 200. In this recording processing, an encryption channel is established between the encryption engine 103 in the recording/reproducing device 100 and the encryption engine 203 in the storage device 200. Through this encryption channel, the license data LIC are transmitted from the recording/reproducing device 100 to the storage device 200. FIG. 13 and FIG. 14 show processings done by the encryption engine 103 in the recording/reproducing device 100, the controller 101 in the recording/reproducing device 100 and the encryption engine 203 in the storage device 200, respectively.

Firstly, the recording/reproducing device 100 issues a certificate output instruction to the storage device 200 (S102). When the controller 201 receives normally the certificate output instruction (S104), the controller 201 instructs the encryption engine 203 to output a certificate and reads out the certificate C[KPd2] from the encryption engine 203 so as to output it to the controller 101 (S106). When the controller 101 acquires the certificate C[KPd2] from the storage device 200, the controller 101 transmits it to the encryption engine 103 (S108).

As the control unit 130 in the encryption engine 103 receives the certificate C[Kpd2] issued from the storage device 200 (S110), the control unit 130 conveys it to the encryption engine 103 while the certificate verification unit 120 verifies the certificate using an authentication key KPa (S112).

If the certificate is not approved (N of S112), the certificate verification unit 120 will convey the error to the control unit 130. The control unit 130 which has been informed of the error sends a notification of verification error to the controller 101 (S190). Upon receipt of the error notification (S192), the controller 101 aborts the processing.

If the certificate is approved (Y of S112), the control unit 130 will produce the challenge key Kc1 using the random number generator 121. Then the challenge key Kc1 produced is conveyed to the first encryption unit 122 and the first decryption unit 123. This challenge key is stored in the first decryption unit 123 (S114). The first encryption unit 122 encrypts this challenge key Kc1 using the public key KPd2 retrieved from the certificate C[KPd2] so as to produce the encrypted challenge key E(Kpd2, Kc1). Then the encryption challenge key E(KPd2, Kc1) produced is combined with the certificate C[KPd1] outputted from the certificate output unit 129 and thereby the first challenge information E(KPd2, Kc1)∥C[KPd1] is produced. The thus produced first challenge information E(KPd2, Kc1)∥C[KPd1] is sent to the controller 101 (S116).

Upon receipt of the first challenge information E(KPd2, Kc1)∥C[KPd1] from the encryption engine 103 (S118), the controller 101 issues a first challenge information verification instruction to the storage device 200 (S120). As the controller 201 receives the first challenge information verification instruction, the storage device 200 makes a request to the controller 101 that the first challenge information E(KPd2, Kc1)∥C[KPd1] be inputted to the storage device 200 (S122). In response to this request, the controller 101 outputs the first challenge information E(KPd2, Kc1)∥C[KPd1] to the storage device 200 (S124).

As the storage device 200 receives the first challenge information E(KPd2, Kc1)∥C[KPd1] (S126), the control unit 220 in the encryption engine 203 retrieves a certificate C[KPd1] from the first challenge information E(KPd2, Kc1)∥C[KPd1] and coveys the retrieved certificate C[KPd1] to the certificate verification unit 223. The certificate verification unit 223 verifies the thus conveyed certificate C[KPd1] using the verification key KPa and conveys its verification result to the control unit 220 (S128).

If the certificate is not approved (N of S128), the certificate verification unit 223 will convey the notification of verification error to the control unit 220. Then the control unit 220, which has been notified of the verification error, sends the notification of verification error to the controller 101 via the storage interface 202 (S194). Upon receipt of the notification of verification error (S192), the controller 101 aborts the ongoing processing.

If the certificate is approved (Y of S128), the control unit 220 will retrieve the public key KPd1 and the encrypted challenge key E(KPd2, Kc1) from the first challenge information E(KPd2, Kc1)∥C[KPd1] and convey them to the first encryption unit 225 and the first decryption unit 224, respectively. The first encryption unit 225 stores the thus conveyed public key KPd1. The first decryption unit 224 decrypts the thus conveyed encrypted challenge key E(KPd2, Kc1) using its own secret key Kd2 so as to retrieve the challenge key Kc1 (S130). The thus retrieved challenge key Kc1 is conveyed to the second encryption unit 226.

On the other hand, when the processing of the first challenge information verification instruction has come to an end in the storage device 200, the controller 101 issues a second challenge information generation instruction to the storage device 200 (S132). When the controller 201 in the storage device 200 receives the second challenge information generation instruction (S134), according to the instructions from the control unit 220 the first encryption unit 225 in the encryption engine 203 encrypts the public key KPp2 that pairs with the secret key Kp2 stored secretly in the first encryption unit 225 and the data where its own identification information DID has been combined together, so as to produce the encrypted individual information E(KPd1, KPp2∥DID). And this encrypted individual information E(KPd1, KPp2∥DID) is conveyed to the second encryption unit 226. The second encryption unit 226 encrypts the encrypted individual information E(KPd1, KPp2∥DID) using the challenge key Kc1 stored in the S130, so as to produce the second challenge information E(Kc1, E(KPd1, KPp2)∥DID)) (S136).

When the processing of the second challenge information generation instruction is completed in the storage device 200, the controller 101 issues an second challenge information output instruction (S138). Upon receipt of the second challenge information output instruction (S140), the controller 201 reads out the second challenge information E(Kc1, E(KPd1, KPp2)∥DID)) from the encryption engine 203 and outputs it to the controller 101 (S142). Upon receipt of the second challenge information E(Kc1, E(KPd1, KPp2)∥DID)) from the storage device 200, the controller 101 sends this second challenge information to the encryption engine 103 (S144).

Upon receipt of the second challenge information E(Kc1, E(KPd1, KPp2)∥DID)), the control unit 130 in the encryption engine 103 conveys it to the first decryption unit 123. The first decryption unit 123 decrypts the thus conveyed second challenge information E(Kc1, E(KPd1, KPp2)∥DID)) using challenge key Kc1 stored therein, and retrieves the encrypted individual information E(KPd1, KPp2∥DID) so as to convey it to the second decryption unit 124. The second decryption unit 124 decrypts this encrypted individual information using its own secret key Kd1 so as to retrieve the public key KPp2 and the identification information DID of the storage device, and conveys the public key KPp2 and the identification information DID to the second decryption unit 125 and the control unit 130, respectively (S146).

Upon receipt of the identification information DID, the control unit 130 compares it with the identification information DID stored in the log storage unit 131 (S150). At this time, the identification information DID of the storage device connected most recently is recorded in the log storage unit 131. If the identification information DID agrees with one stored in the log storage unit 131 (Y of S150), it will be determined that the storage device is the same as the previous one, and the step will proceed to S154 while the record in the log storage unit 131 is left intact. If it does not agree (N of S150), it will be determined that the storage device has been replaced. In this case, the contents recorded in the log storage unit 131 no longer serve the purpose. Thus the contents recorded in the log storage unit 131 are deleted, and identification information DID acquired anew in S146 is recorded (S152). In this manner, the information necessary for the recovery in the transfer of the license data LIC for the storage device 200 is ready to be stored in the log storage unit 131. Then, proceed to S154.

The control unit 130 causes the random number generator 121 to produce the bus key Kb1 and store it (S154). Then the bus key Kb1 stored is conveyed to the second decryption unit 125 and the third decryption unit 126. The second decryption unit 125 decrypts this bus key Kb1 using public key Kpp2 of the storage device acquired in S146 so as to produce the connection information E(KPp2, Kb1). Then the second decryption unit 124 sends the thus produced connection information E(KPp2, Kb1) to the controller 101 (S156).

Upon Receipt of the Connection Information E(Kpp2, Kb1) from the decryption engine 103 (S158), the controller 101 issues a connection information input instruction to the storage device 200 (S160). As the controller 201 receives the connection information input instruction, the storage device 200 makes a request to the controller 101 that the connection information E(KPp2, Kb1) be inputted to the storage device 200 (S162). In response to this request, the controller 101 outputs the connection information E(KPp2, Kb1) to the storage device 200 (S164).

As the storage device 200 receives the connection information E(KPp2, Kb1), the second decryption unit 227 in the encryption engine 203 decrypts the connection information E(KPp2, Kb1) using its own secret key Kp2 stored therein, retrieves the bus key Kb1 (S166) and stores it therein (S168). The bus key Kb1 stored is conveyed to the third encryption unit 228. Through the procedure up to this step, the bus key Kb1 is shared between the encryption engine 103 and the encryption engine 203.

On the other hand, as the processing of the connection information input instruction is completed in the storage device 200, the controller 101 proceeds to S180 to write and transfer the normal license data (LIC write-transfer processing). Then the write of the license data LIC is carried out (S180). The processing of writing and transferring the license data LIC (LIC write-transfer processing) will be discussed later in detail.

As S180 comes to an end, the controller 101 determines if new license data LIC are to be written or not (S182). If new license data LIC are to be written to the storage device 200 (Y of S182), return to S180 again and write the license data. If new license data LIC are not to be written thereto (N of S182), the processing will be terminated.

FIG. 14 is a flowchart showing write-transfer processing of license data (LIC write-transfer processing) in FIG. 13. Prior to the processing shown in this flowchart, the encryption engine 103 and the storage device 200 (encryption engine 203) share the bus key Kb1; the encryption engine 103 stores the public key KPp2 of the storage device 200; and the identification information DID of the storage device 200 is recorded in the log storage unit 131 in the encryption engine 103.

The controller 101 issues a session information generation instruction to the storage device 200 (S200). As the controller 201 in the storage device 200 receives the session information generation instruction (S202), the random number generator 221 in the encryption engine 203 produces the session key Ks2 according to instructions from the control unit 220 and conveys the thus produced session key Ks2 to the third encryption unit 228 and the third decryption unit 229 (S204). Subsequently, the third encryption unit 228 produces session information E(Kb1, Ks2) by encrypting the thus conveyed session key Ks2 with the bus key Kb1 (S206). As the processing of the session information generation instruction is completed in storage device 200, the controller 101 issues a session information output instruction (S208). As the storage device 200 receives the session information output instruction (S210), the controller 201 reads out the session information E(Kb1, Ks2) from the encryption engine 203 so as to output it to the controller 101.

As the controller 101 receives the session information E(Kb1, Ks2) from the storage device 200 (S214), the controller 101 concatenates this to the address data ADR of the storage device 200 and sends the concatenated data to the encryption engine 103 (S216). The address data ADR is an address specified when the license data are to be recorded later.

Upon receipt of the session information E(Kb1, Ks2)∥ADR where the data address is concatenated, the control unit 130 in the encryption engine 103 decomposes it into the session information E(Kb1, Ks2) and the address ADR and conveys the session information E(Kb1, Ks2) to the third decryption unit 126. The third decryption unit 126 decrypts this session information E(Kb1, Ks2) using the bus key Kb1 conveyed from the random number generator 121 and retrieves Ks2 (S218).

In case a write operation of the license data should fail, the control unit 130 adds the license data LIC and the separated address data ADR to the log storage unit 131 by associating them with information (identification information DID) that identifies the storage device 200 to which the license data is to be transferred (S220). The license data are recorded statically into the log storage unit 131. This is because the recording is designed to be used for a rewrite access of the license data even in cases where a write operation of the license data is interrupted due to accidents such as power discontinuity.

Subsequently, the third decryption unit 127 in the encryption engine 103 encrypts the license data LIC using the public key KPp2 of the storage device 200 so as to produce E(KPp2, LIC), and sends this E(KPp2, LIC) to the fourth encryption unit 128. The fourth encryption unit 128 further encrypts the thus conveyed E(KPp2, LIC) using the session key Ks2 issued by the storage device 200 so as to produce the encrypted license data E(Ks2, E(KPp2, LIC)), and conveys this encrypted license data E(Ks2, E(KPp2, LIC)) to the controller 101 (S222).

Upon receipt of the encrypted license data E(Ks2, E(KPp2, LIC)) sent from the encryption engine 103 (S224), the controller 101 issues a license data write instruction to the storage device 200 (S226). This license data write instruction contains therein the address data ADR that specifies the recording position on the tamper-resistant storage unit 204. This address data ADR is the same value as the value sent to the encryption engine 103 at S216. Here, the address indicates a logic address but does not directly specify the recording position in the tamper-resistant storage unit 204. The data recorded by specifying its address is managed by the controller 201 so that the data can be read out by specifying the same address. The address may be a physical address that indicates the position in the tamper-resistant storage 204.

Upon receipt of the license data write instruction issued by the controller 101, the storage device 200 requests the encrypted license data from the controller 101 (S228). In response to this request, the controller 101 outputs the encrypted license data E(Ks2, E(KPp2, LIC)) to the storage device (S230).

Upon receipt of the encrypted license data E(Ks2, E(KPp2, LIC)), the storage device 200 conveys this to the third decryption unit 229 in the encryption engine 203. The third decryption unit 229 decrypts the encrypted license data E(Ks2, E(KPp2, LIC)) using the session key Ks2 stored therein and retrieves the license data E(KPp2, LIC) encrypted with its own public key KPp2. Then the license data E(KPp2, LIC) retrieved is conveyed to the fourth decryption unit 230.

The fourth decryption unit 230 decrypts the license data E(KPp2, LIC), conveyed from the third decryption unit 229, using the secret key Kp2 that pairs with public key KPp2, retrieves the license data LIC (S244), and conveys this to the control unit 220 via the local bus 240.

The control unit 220 retrieves the identification information LID from the license data LIC and conveys it to the log storage unit 131. The control unit 220 also outputs the license data LIC to the data bus 210. The controller 201 stores the license data LIC outputted to the data bus 210, at the address specified in the tamper-resistant storage unit 204 (S246). Then the completion notice is outputted to the controller 101 (S248).

Upon receipt of the completion notice outputted from the storage device 200, the controller 101 outputs this to the encryption engine 103 (S250). Upon receipt of the completion notice (S252), the encryption engine 103 checks the LID, removes the applicable ADR∥LID from the log storage unit 131 (S254), and terminates the ongoing processing.

With the above procedure, the license data LIC necessary for the decryption and reproduction of the encrypted content are recorded in the storage device 200. The encrypted contents are normal data and are recorded by a normal command at the storage device 200, so that the explanation thereof is omitted here.

Note that the order in which the license data LIC and the encrypted content data are recorded may be optional. Further, the license data LIC may be recorded in such a manner that a secure command is issued by dividing it into several parts during unoccupied hours in the recording of the encrypted content data.

The encryption communication by both the encryption engines is performed by following the same procedure as the above if the license data are to be sent from the storage device 200 to the recording device 100. When the primary-use license data are recorded from the recording/reproducing device 100 into the storage device 200, when the primary-use license data recorded in the storage device 200 are read out by the recording/reproducing device 100 and when the secondary-use license data are to be recorded from the recording/reproducing device 100 into storage device 250, the transmission and reception of the license data using the above-described encryption channel prevents the leakage of the license data and therefore the content data can be protected.

### EMBODIMENTS

In what is to follow, a description is given of a technique for duplicating content data for personal backup purposes.

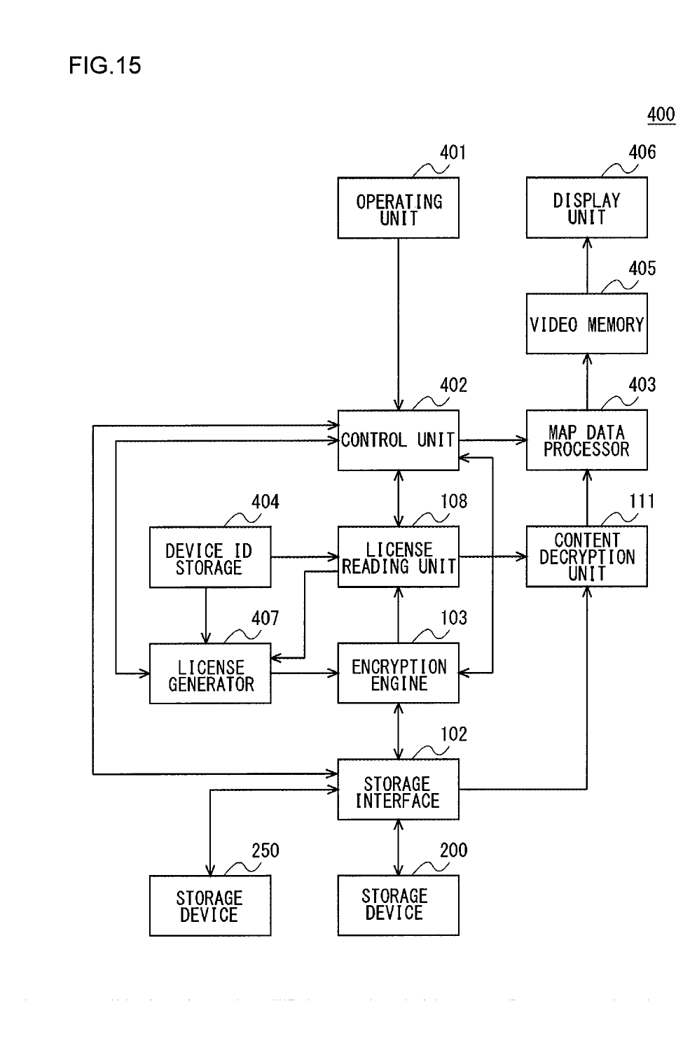

FIG. 15 shows a structure of a car navigation device which is an example of a content management apparatus according to an embodiment. A car navigation device 400 includes an operating unit 401, a control unit 402, a map data processor 403, a device ID storage 404, a video memory 405, a display unit 406, a storage interface 102, an encryption engine 103, a license reading unit 108, and a content decryption unit 111. Map data displayed in the car navigation device 400 are stored in the storage device 200, which is a freely removable hard disk device. The same components as those of the recording/reproducing device 100 of FIG. 2 described in the base technology are given the identical reference numerals.

The operating unit 401 receives an operation instruction from the user. The control unit 402 controls other components via the operating unit 401 in accordance with the operation instruction received from the user. Thereby, the control unit 402 achieves functions of a car navigation system by, for example, displaying a map of the periphery of the present location, destination or the like, setting a destination and searching and displaying routes to the destination. In response to instructions from the control unit 402, the map data processor 403 processes map data decrypted by the content decryption unit 111 and transfers it to the video memory 405 so as to display it on the display unit 406.

The map data are supplied, in the form of being stored in the storage device 200, to the user. In the storage device 200, the map data are encrypted by the content key Kc and stored in the normal-data storage unit 205 wherein the content key Kc is stored in the tamper-resistant storage unit 204 as part of the license data.

In the present embodiment, making an unauthorized copy of the map data onto the storage device 200 and making use of such an unauthorized copy in other apparatuses is prohibited and, at the same time, making a copy of them for backup purposes in the storage device 250 in preparation for the failure or the like of the storage device 200 is permitted. Thereby, the present embodiment proposes a technique to enhance the user's convenience.

In the present embodiment, the structure is such that the use of the storage device 250 where the data have been duplicated for backup purposes using the “binded Ks” described in the base technology is allowed only in the car navigation device 400 owned by the user and the map data cannot be used in any other devices. That is, the content key Kc, which is the decryption key for the encrypted map data copied to the storage device 250, is encrypted or scrambled, as “binded Kc”, using information, for instance, the device ID, which is unique to the car navigation device 400 and is so secretly kept as not to be leaked to the outside. As a result, the use of the map data in a plurality of devices resulting from unauthorized duplication can be prevented.

As in the conventional practice, it is also possible to ship from factory the storage devices 200 that store the map data bound to the information, such as device IDs, unique to the car navigation device 400 in order that the map data are usable only in the car navigation device 400 owned by the user and the map data cannot be used in any other devices. In such a case, it is required that different data must be stored in the storage device 200 of each car navigation device at the time of shipment, which is therefore not preferable from viewpoints of manufacturing and shipment costs.

The original content key Kc stored in the storage device 200 that the user has purchased is not bound to the device ID, and it can be used in the other devices. If it is allow to produce duplicates on a plurality of devices based on the encrypted map data and license data stored in this storage device 200, there will be produced a plurality of storage devices that store the map data usable in the other devices. Thus, according to the present embodiment, the duplication of the license data, containing the original content key Kc, just as they are is prohibited. Before storing the backup license data in the storage device 250, the content key Kc within the original license data recorded in the storage device 200 is also bound to the device so that it cannot be used in the other devices. Then, copying this bound license data enables the copying of the backup license data to the storage device 250. This can prevent the use of the map data obtained as a result of unauthorized duplication. The binding of the original content Kc recorded in the storage device 200 may be done at the start of use of the map data or may be done when at first the license data are copied to other storage devices for the backup purposes. Thus, the binding thereof may be done at either timing until when a duplicate is prepared at first.

As described above, according to the present embodiment, the same data are stored in the storage device 200 at the time of shipment from factory; and when the user starts using it or when the user makes a first copy for the backup purposes, the data is bound to the device ID so that the data cannot be used except by the car navigation device 400 thus bound. As a result, the manufacturing cost of the storage devices 200 can be reduced.

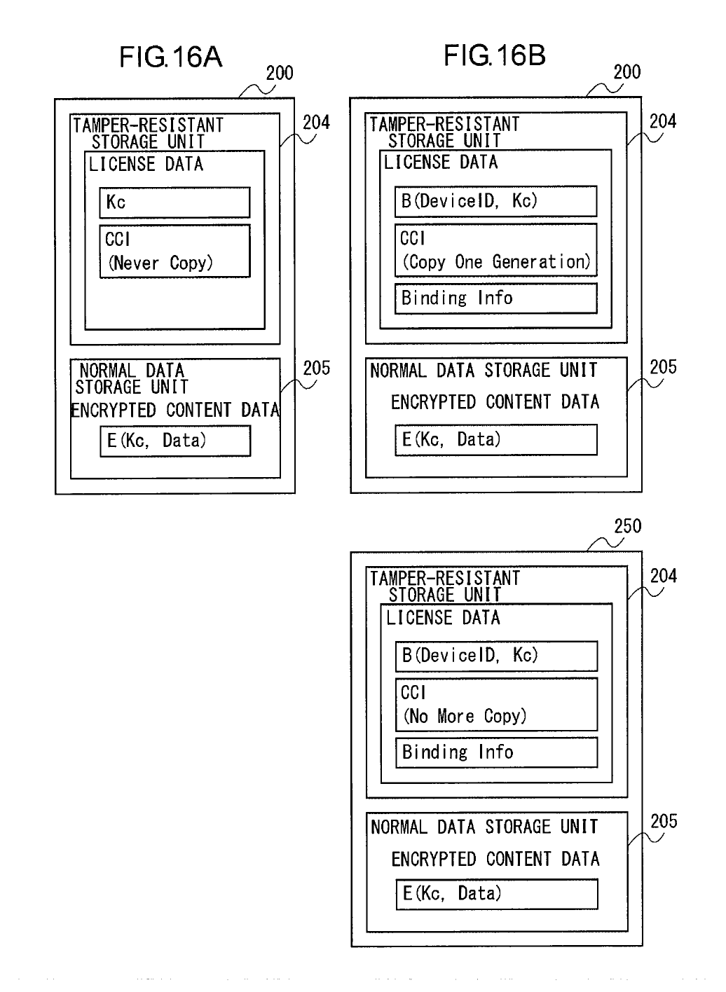

FIGS. 16(a) and 16(b) schematically show internal data of a storage device. Here, “Data” indicates map data. CCI (Copy Control Information) is employed as the usage control information. CCI has four states: “Never Copy”, “Copy One Generation”, “No More Copy”, and “Not Asserted” which indicate “prohibition of duplication”, “duplication permitted for the first generation only”, “This is a copy and further duplication prohibited”, and “No limit on duplication”, respectively. FIG. 16(a) shows internal data of the original storage device 200. The storage device 200 at the time of shipment from factory has map data E(Kc, Data), encrypted with the content key Kc, stored in the normal data storage unit 205 and has the license data, which contain the content key Kc and CCI (Never Copy) indicating that no duplication is permitted, stored in the tamper-resistant storage unit 204. FIG. 16(b) shows internal data of a storage device 200 after duplication and a target storage device 250 which is a copying destination. The license data of the after-duplication storage device 200 are replaced by the license data that contain “binded Kc”, “biding info” which is information from which to infer devices to which “binded Kc” has been bound, and CCI (Copy One Generation) indicating a first-generation duplication. As a result, it becomes possible to duplicate the license data for backup purposes. The encrypted map data E(Kc, Data) stored in the normal data storage 205 remain intact and no re-encryption is performed thereon. The encrypted map data E(Kc, Data) is duplicated onto the normal data storage unit 205 of the target storage device 250, and the license data containing “binded Kc”, “binding info” and CCI (No More Copy) indicating that no more copy is permitted are stored in the tamper-resistant storage unit 204 of the target storage device 250. Note that “Never Copy” may be used in CCI instead of “No More Copy”.

A description is now given of an operation of each constitution. A description is first given of an operation when the original license data are bound to a device. When the user requests, via the operating unit 401, the use of map data or the duplication of license data stored in the storage device 200, the control unit 402 first controls the storage interface 102 and the encryption engine 103 and causes them to read out the license data, which contain the content key Kc, from the storage bus 200. The license data thus read out are sent to the license reading unit 108 where whether the content key KC is bound to the device ID or not is determined. If the content key KC is not bound to the device ID, it will be determined by the license reading unit 108 that the license data read out are the original license data which is not a duplicate. If it is the original license data, the control unit 402 will so control a license generator 407 that the content key Kc in the read-out license data is encrypted using the device ID stored in the device ID storage 404. And “binded Kc” will be generated and the content key Kc in the license data will be changed to the “binded Kc”. The license generator 407 further changes CCI (Copy Control Information) of license data to “Copy One Generation” and adds information (information different from the device ID) from which to infer the device ID of the car navigation device 400, for example, the serial number or the like of the car navigation device 400, to the license data. The license data thus generated are transferred to the storage device 200 via the encryption engine 103 and the storage interface 102, so that the license data are overwritten and replaced by the license data recorded in the tamper-resistant storage unit 204 of the storage device 200. As a result, the map data using the license data recorded in the storage device 200 cannot be used in any device other than this car navigation device 400.

When the license data are to be copied to the storage device 250, the license generator 407 generates “binded Kc”, information from which to infer the device ID of the car navigation device 400 and license data where “No More Copy” or “Never Copy” is set as CCI, as license data to be recorded in the target storage device 250 which is a copying destination. The license data thus generated are transferred to the storage device 250 via the encryption engine 103 so as to be recorded in the tamper-resistant storage unit of the storage device 250. Since the encrypted map data may be treated the same way as with the normal data, the encrypted map data may be duplicated by the car navigation device 400 or may be duplicated by the use of other devices such as a personal computer.

When a backup is to be made to still another storage device, the backup may be copied to another storage device from a source storage device 200, which is a copying source, by the use of another device having the encryption engine 103 and capable of inputting and outputting the license data. In this case, too, the content key Kc is bound to the device ID of the car navigation device 400 that has produced the copy first, so that it cannot be used in any device other than said car navigation device 400.

A description is now given of an operation of each constitution when the map data in the storage device 200 are to be read out. While the content key stored in the storage device 200 is not bound to the device ID, the content key Kc is obtained by reading out the license data via the encryption engine 103 and therefore the content decryption unit 111 can decrypt the map data stored in the storage device 200. If the data of the storage device 200 are copied to the storage device 250 and the content key is bound to the device ID, the license reading unit 108 analyzes the license data read out via the encryption engine 103 so as to obtain the content key Kc. The license reading unit 108 first determines whether license data is the one that has been bound to its own device or not, by referencing “binding info” contained in said license data. If the license data are determined to be bound to its own device, the license reading unit 103 will read out the device ID from the device ID storage 404 and obtain the content key Kc from the “binded Kc” using the read-out device ID. The content key Kc thus obtained is conveyed to the content decryption unit 111. Thereby, the content decryption unit 111 decrypts the encrypted map data. The map data duplicated in the storage device 250 can be decrypted in a similar manner.

To other devices than the device to which the license data has been bound, the device ID bound thereto cannot be known. Hence, in this case, the content key Kc cannot be obtained. Thus, even if an unauthorized copy of the encrypted map data or license data is made, the map data cannot be decrypted. This can prevent the unauthorized use thereof and protect copyright holders appropriately.

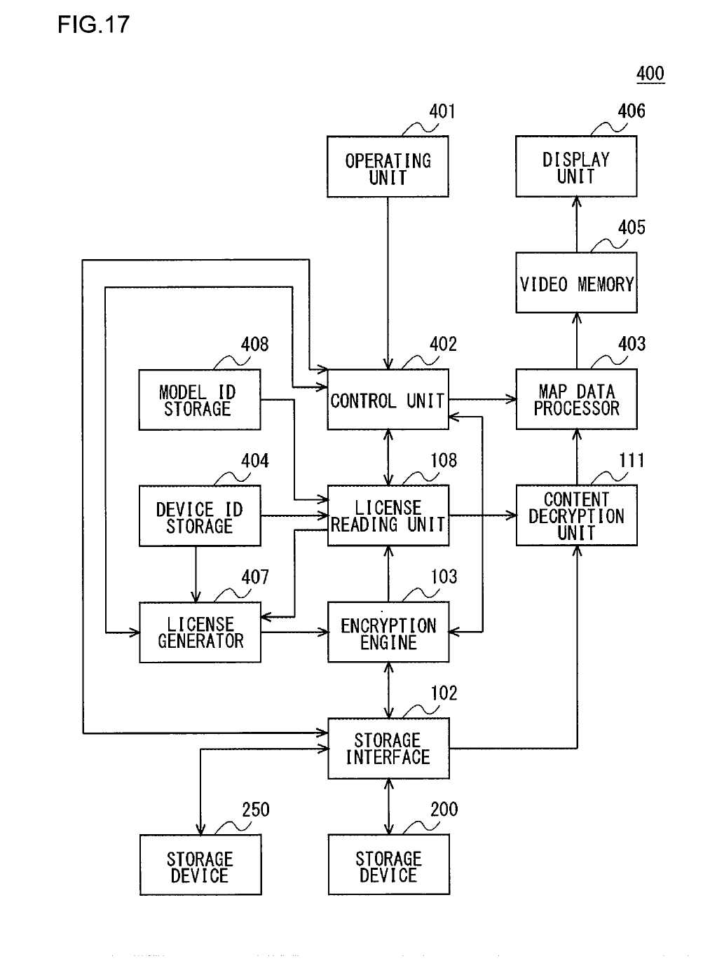

FIG. 17 shows another exemplary structure of a car navigation device. A car navigation 400 further includes a model ID storage 408 in addition to the components of the car navigation device 400 shown in FIG. 15. A model ID is assigned to identify the same type of device group and is stored in the model ID storage 408 at the time of shipment of car navigation devices 400 from factory.

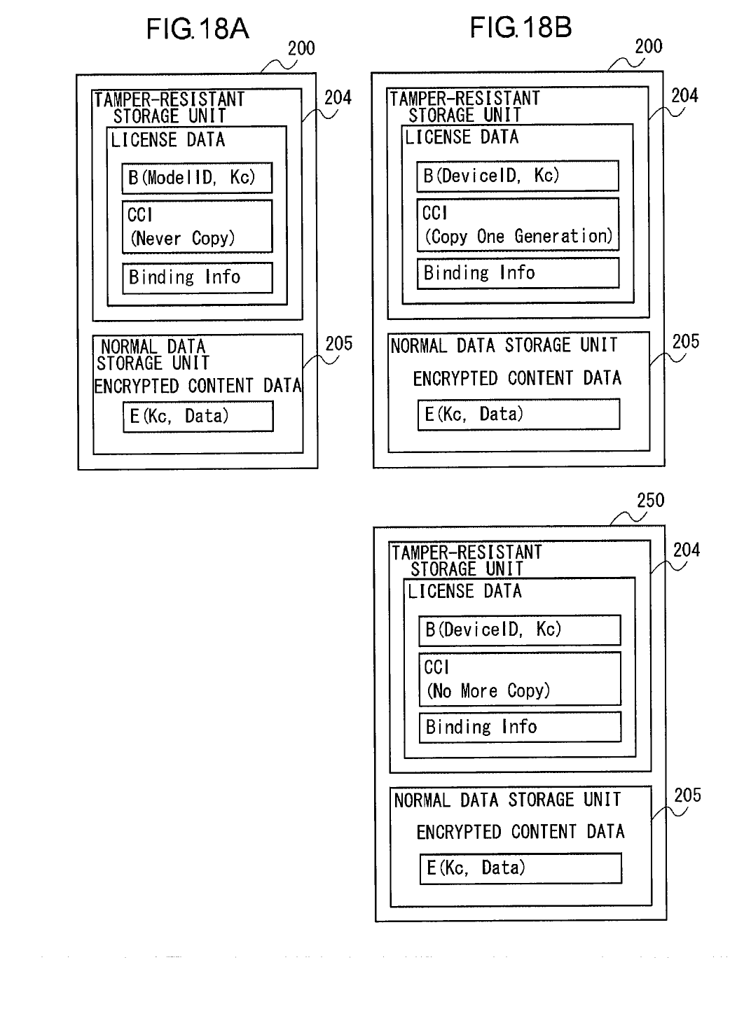

FIGS. 18(a) and 18(b) schematically show internal data of a storage device in the example shown in FIG. 17. In the example shown in FIG. 18(a), at the time of shipment from factory the license data stored in the storage device 200 are bound to the model ID to which the content key has been assigned in order to identify the same type of device group. Thus, when the car navigation device 400 decrypts the map data stored in the storage device 200 or duplicates the license data, the license reading unit 108 obtains a content key Kc from the content key Kc bound to the model ID, by the use of the model ID read out from the model ID storage 408. Here, the bound content key Kc is contained in the license data acquired via the encryption engine 103. Note that whether the content key Kc in the read-out license data is bound to the model ID or the car navigation device 400 is determined by the “binding info”. The license data usable by the car navigation device 400 are data where the content key Kc is bound to the device ID of the car navigation device 400 itself or the model ID of a device group to which the car navigation device 400 belongs. The license data containing the content key Kc bound to the model ID of a device group to which the car navigation device 400 belongs are the original license data. FIG. 18(b) shows internal data of a storage device 200 after duplication and a target storage device 250 which is a copying destination. The internal data of the after-duplication storage device 200 and the storage device 250 are similar to those shown in FIG. 16(b).

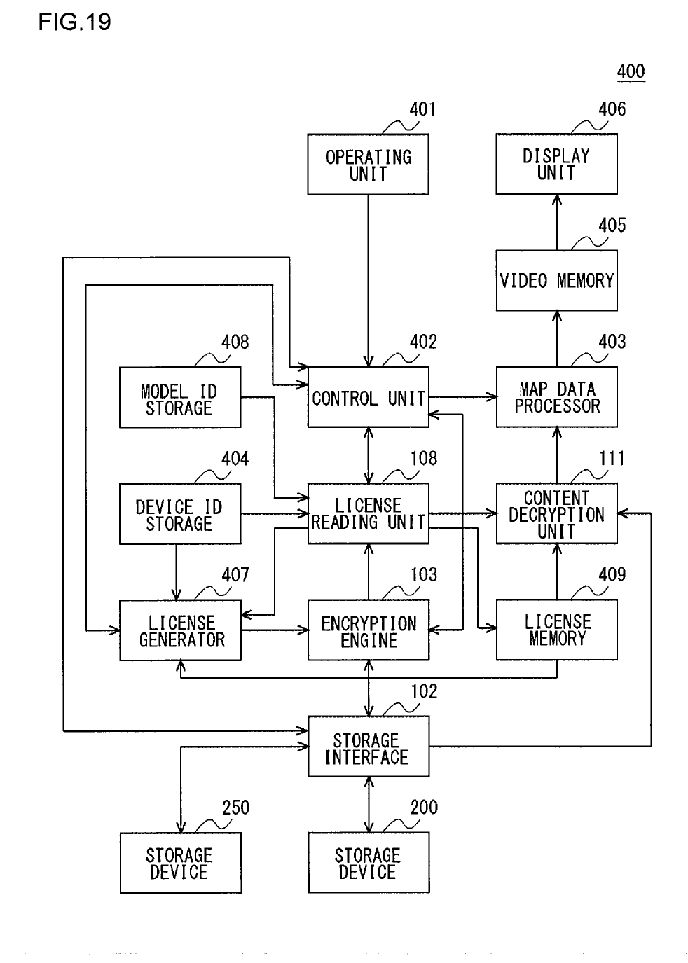

FIG. 19 shows still another exemplary structure of a car navigation device. A car navigation device 400 shown in FIG. 19 further includes a license memory 409 in addition to the components of the car navigation device 400 shown in FIG. 17. The license memory 409 is a memory for storing data so that the data are not leaked to the outside. The license memory 409 temporarily or continuously stores license data that contain unbound content keys Kc decrypted using the model IDs or device IDs by the license reading unit 108.

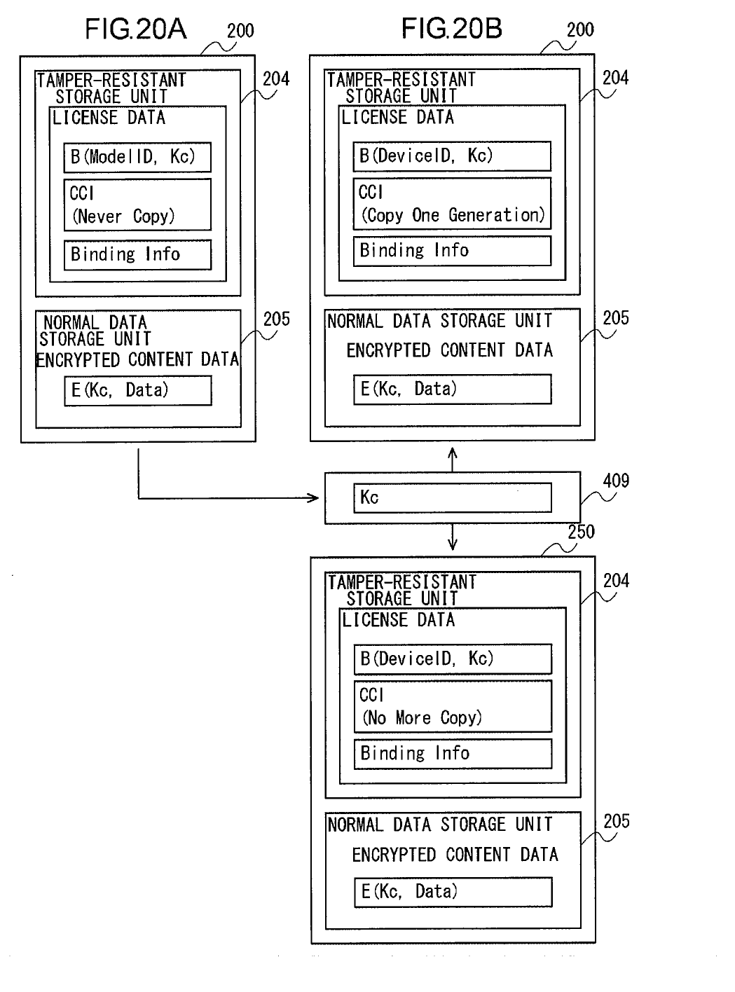

FIGS. 20(a) and 20(b) schematically show internal data of a storage device in the example shown in FIG. 19. The example shown in FIG. 20(a) shows the internal data similar to that of the storage device 200 shown in FIG. 18(a). When the use of this storage device 200 starts or a duplicate is to be made, the license reading unit 108 obtains a content key Kc from the content keys Kc bound to the model ID, by the use of the model ID read out from the model ID storage 408. Here, the content keys Kc are contained in the license data acquired via the encryption engine 103. The control unit 402 stores the thus obtained content key Kc to the license memory 409. The content key Kc stored in the license memory 409 may be erased when the duplication for backup purposes has been completed. Or the content key Kc stored in the license memory 409 may be stored and, thereafter, the content decryption unit 111 may decrypt the encrypted map data using the content key Kc stored in the license memory 409. FIG. 20(b) shows internal data of a storage device 200 after duplication and a target storage device 250 which is a copying destination. The content key Kc stored in the license memory is a copying source; and “binded Kc” is copied onto the storage device 200 and the storage device 250. This is equivalent to moving once the content key of the original storage device 200 to the license memory 409 (deleting it from the storage device 200) and then copying the “binded Kc”, which is bound to the car navigation device 400, to the original storage device 200 and the copying destination, namely the storage device 250, from the license memory.

The invention has been explained based upon the embodiments. These exemplary embodiments are intended to be illustrative only and it will be obvious to those skilled in the art that various modifications to constituting elements and processes could be developed and that such modifications are also within the scope of the present invention.

In the above-described embodiment, for example, the function block of encryption and the function block of decryption are provided separately in the encryption engine but a circuitry may be shared between these structural components. As a result, the circuit size can be suppressed, thus contributing to a reduced size and reduction in power consumption.

In the embodiment, the processing for reading out the license data from the storage device 200 is described separately for each of three operations, namely, the binding, the use of the map data and the duplication of the license data. However, when the binding is to be performed in response to a request for the use of the map data, the readings of license data in two processings can be put to common use. Similarly, when the binding is to be performed in response to a request for the duplication of the license data, the readings of license data in two processings can be put to common use.

If the duplication or removal (transfer) of license data between storage devices is allowed, the license data may be duplicated or moved to the other storage device using a method similar to the base technology. If the license data are moved, the license data will be removed from the storage device, in which the original license data are stored, after the duplication of the license data has been completed.

In the embodiment, a description is given of a case where the storage device 200 has the same functions as the storage device 250. However, it is not necessarily the case that each storage device includes the encryption engine therein. It suffices if the recording/reproducing device 100 alone performs decryptable encryption on the entire primary-use license and records it. In this case, the entire primary-use license data are recorded in such a manner that the entire primary-use data are bound to the recording/reproducing device 100, so that the content key needs not be bound as described in the embodiment.

In the embodiment, a description is given of an example where the storage devices 200 that store the encrypted map data and the original license data are shipped from factory. However, the encrypted map data and the original license data may be distributed from a server apparatus via a network such as the Internet. In this case, too, the server apparatus has only to distribute the same data, so that the management cost therefor is reduced. Also, users no longer need to send information on their devices, so that the user's convenience is enhanced.

In the embodiment, a description is given using the map data and the car navigation device as examples. However, the present embodiment is not limited to the map data and the car navigation device. For example, the present embodiment may be intended for the use of general content data such video data, audio data and programs, and is applicable to a content management apparatus that manages such content data.

### INDUSTRIAL APPLICABILITY

The present invention is applicable to a content management apparatus for managing the contents.

1. A content management method for reading content data encrypted with a content key and the content key from a portable storage device that stores the content data and the content key in order to use the encrypted content data or in order to duplicate the content key, the method comprising:
receiving a request for a use of the content data or a duplication of the content key;
reading the content key from the storage device;
determining whether or not the read content key is encrypted or converted using information which is unique to any utilization apparatus capable of decrypting the encrypted content data and is so secretly kept as not to be leaked to the outside;
encrypting or converting the content key using the information which is unique to a utilization apparatus capable of decrypting the encrypted content data and is so secretly kept as not to be leaked to outside of the utilization apparatus, when the content key is not encrypted or converted;
sending the encrypted or converted content key to the storage device so as to be recorded in substitution for the content key; and
given that information indicating that duplication of the content key is prohibited is stored in the storage device, storing information indicating that duplication of the content key is permitted, in place of the information indicating prohibition.

2. A content management method according to claim 1, further comprising recording the encrypted or converted content key in a storage device which is a copying destination, when the request for a duplication of the content key is received.

3. A content management method according to claim 1, further comprising storing the read content key in a memory for storing data so secretly as not to be leaked to the outside.

4. A content management method according to claim 1, wherein the apparatus stores a model ID assigned to identify a same type of apparatus group, and
wherein the content key is encrypted or converted with the model ID,
the method further comprising decrypting or de-converting the content key encrypted or converted with the model ID prior to said encrypting or converting the content key.

5. A content management method according to claim 1, wherein the information which is unique to the utilization apparatus and is so secretly kept as not to be leaked to the outside is an ID of the apparatus.

6. A content management method according to claim 1, wherein the content key is encrypted and inputted/outputted between the storage device and the apparatus.

7. A content management method according to claim 1, wherein when the request for a use of the content data is received, the method further comprises:
reading the content key from the storage device;
determining whether or not the read content key is encrypted or converted using information which is unique to a utilization apparatus and is so secretly kept as not to be leaked to the outside;
decrypting or de-converting the content key using the information which is unique to its own apparatus and is so secretly kept as not to be leaked to the outside, when the content key is encrypted or converted;
reading the encrypted content key from the storage device; and
decrypting the read encrypted content data using the decrypted or de-converted content key.

8. A content management method according to claim 1, wherein the content data are map data, and the apparatus is a car navigation device.

9. A content management apparatus, comprising:
an input/output unit which inputs and outputs a content key used to decrypt encrypted content data between portable storage devices;
a unique information storage which stores information unique to its own apparatus or a same type of apparatus group including its own apparatus so that the unique information is not leaked to the outside;
a generation unit which encrypts or converts the content key with the unique information;
an operating unit which receives a request for a use of the content data using the content key or a duplication of the content key; and
a control unit which acquires the content key stored in the storage device by said input/output unit, encrypts or converts the acquired content key by said generation unit using the unique information, sends the encrypted or converted content key to the storage device by said input/output device so as to be recorded in substitution for the content key, when the request for a use of the content data or a duplication of the content key is received, and, given that information indicating that duplication of the content key is prohibited is stored in the storage device, stores information indicating that duplication of the content key is permitted, in place of the information indicating prohibition.

10. A content management apparatus according to claim 9, wherein when the request for a duplication of the content data is received, said control unit sends the encrypted or converted content key to a storage device which is a copying destination by said output/input unit.

11. A content management apparatus according to claim 9, further comprising a license memory which stores data so secretly as not to be leaked to the outside,
wherein when the request for a use of the content data or a duplication of the content key is received, the content key stored in the storage device is moved to said license memory, encrypts or converts the content key stored in said license memory by said generation unit using the unique information, and sends the encrypted or converted content key to the storage device by said output/input unit so as to be duplicated onto the storage device.

12. A content management apparatus according to claim 9, further comprising:
a model ID storage which stores a model ID assigned to identify a same type of apparatus group; and
a license reading unit which decrypts or de-converts the content key with the model ID stored in said model ID storage, when the content key acquired from the storage device is encrypted or converted with the model ID.

13. A content management apparatus according to claim 9, wherein the unique information is a device ID of the content management apparatus.

14. A content management apparatus according to claim 9, wherein when inputting and outputting the content key to and from the storage device, said input/output unit inputs and outputs the content key after encrypting the content key.

15. A content management apparatus according to claim 9, further comprising:
a license reading unit which decrypts or de-converts the content key encrypted or converted with information unique to the content management apparatus; and
a content decryption unit which decrypts the encrypted content data using the content key,
wherein when a request for decryption of the content data is received, said control unit acquires the content key stored in the storage device from said input/output unit; and when the acquired key is encrypted or converted, the content key is decrypted or de-converted by said license reading unit so as to be supplied to said content decryption unit and the encrypted content data acquired from the storage device are decrypted by said content decryption unit.

16. A content management apparatus according to claim 9, wherein the content data are map data, and the content management apparatus is a car navigation device.
